(19) United States
(12) Patent Application Publication
(10) Pub. No.: US 2025/0003750 A1
(43) Pub. Date: Jan. 2, 2025

(54) COMPOSITE SENSOR

(71) Applicant: Panasonic Intellectual Property Management Co., Ltd., Osaka (JP)

(72) Inventors: Kazufumi NISHIKAWA, Osaka (JP); Yuki MAEGAWA, Fukui (JP)

(73) Assignee: Panasonic Intellectual Property Management Co., Ltd., Osaka (JP)

(21) Appl. No.: 18/703,565

(22) PCT Filed: Oct. 11, 2022
(86) PCT No.: PCT/JP2022/037827

§ 371 Date: Apr. 22, 2024

(30) Foreign Application Priority Data
Oct. 25, 2021 (JP) 2021-174195

(51) Int. Cl. G01C 19/5712; G01P 15/125; G01P 15/18

(52) U.S. Cl. CPC G01C 19/5712; G01P 15/125; G01P 15/18

(57) ABSTRACT

A composite sensor includes angular velocity detection elements, acceleration detection elements, and a control circuit. The control circuit includes: acceleration averaging units; a decision processor for determining whether the composite sensor is in an applied state; an acceleration offset magnitude calculator; an acceleration corrector for applying an acceleration correction signal to an acceleration average signal to output a corrected acceleration signal; a signal processor for outputting a quaternion signal based on an angular velocity signal and a corrected acceleration signal; and an acceleration calculator for calculating acceleration information based on the quaternion signal. The acceleration offset magnitude calculator calculates, in accordance with the acceleration information when the composite sensor is not in the applied state, an acceleration correction signal when the composite sensor is in the applied state.

### TECHNICAL FIELD

The present disclosure generally relates to a composite sensor, and more particularly relates to a composite sensor for measuring angular velocity and acceleration.

### BACKGROUND ART

A known composite sensor for measuring angular velocity and acceleration makes offset (bias) correction. A known offset correction method uses the magnitude of static offset, the magnitude of dynamic offset, and the magnitude of transition offset as disclosed in Patent Literature 1, for example. According to Patent Literature 1, the magnitude of static offset is a static average as an average output of the sensor that is standing still. Also, according to Patent Literature 1, the magnitude of dynamic offset is a dynamic average as an average output of the sensor that is moving. Furthermore, according to Patent Literature 1, the magnitude of transition offset is calculated based on the dynamic average and the static average. The composite sensor of Patent Literature 1 makes offset correction using the magnitude of dynamic offset while the composite sensor is moving and using either the magnitude of static offset or the magnitude of transition offset while the composite sensor is standing still. Therefore, the accuracy of the offset correction achieved by such a composite sensor may be insufficiently high in some cases.

### CITATION LIST

### Patent Literature

Patent Literature 1: JP 2016-512328 A

### SUMMARY OF INVENTION

An object of the present disclosure is to provide a composite sensor having the ability to make offset correction highly accurately.

A composite sensor according to an aspect of the present disclosure includes a first angular velocity detection element, a second angular velocity detection element, a third angular velocity detection element, a first acceleration detection element, a second acceleration detection element, a third acceleration detection element, and a control circuit. The first angular velocity detection element detects angular velocity around a first detection axis to output a first angular velocity signal. The second angular velocity detection element detects angular velocity around a second detection axis to output a second angular velocity signal. The third angular velocity detection element detects angular velocity around a third detection axis to output a third angular velocity signal. The first acceleration detection element detects acceleration in a direction aligned with the first detection axis to output a first acceleration signal. The second acceleration detection element detects acceleration in a direction aligned with the second detection axis to output a second acceleration signal. The third acceleration detection element detects acceleration in a direction aligned with the third detection axis to output a third acceleration signal. The control circuit processes the first angular velocity signal, the second angular velocity signal, the third angular velocity signal, the first acceleration signal, the second acceleration signal, and the third acceleration signal. The first detection axis, the second detection axis, and the third detection axis are perpendicular to each other. The control circuit includes a first acceleration averaging unit, a second acceleration averaging unit, a third acceleration averaging unit, a decision processor, an acceleration offset magnitude calculator, an acceleration corrector, a signal processor, and an acceleration calculator. The first acceleration averaging unit calculates a time average of the first acceleration signal to generate a first acceleration average signal. The second acceleration averaging unit calculates a time average of the second acceleration signal to generate a second acceleration average signal. The third acceleration averaging unit calculates a time average of the third acceleration signal to generate a third acceleration average signal. The decision processor determines whether the composite sensor is in an applied state in which at least one of angular velocity or acceleration is applied to the composite sensor. The acceleration offset magnitude calculator calculates magnitude of offset correction with respect to the first acceleration average signal to output a first acceleration correction signal. The acceleration offset magnitude calculator further calculates magnitude of offset correction with respect to the second acceleration average signal to output a second acceleration correction signal. The acceleration offset magnitude calculator further calculates magnitude of offset correction with respect to the third acceleration average signal to output a third acceleration correction signal. The acceleration corrector applies the first acceleration correction signal to the first acceleration average signal to output a first corrected acceleration signal. The acceleration corrector also applies the second acceleration correction signal to the second acceleration average signal to output a second corrected acceleration signal. The acceleration corrector further applies the third acceleration correction signal to the third acceleration average signal to output a third corrected acceleration signal. The signal processor outputs a quaternion signal based on angular velocity information, the first corrected acceleration signal, the second corrected acceleration signal, and the third corrected acceleration signal. The angular velocity information is based on the first angular velocity signal, the second angular velocity signal, and the third angular velocity signal. The acceleration calculator calculates, based on the quaternion signal, at least one of gravitational acceleration or linear acceleration as acceleration information. The acceleration offset magnitude calculator calculates, in accordance with the acceleration information in a second period, the first acceleration correction signal, the second acceleration correction signal, and the third acceleration correction signal for a first period. The second period is a period in which the decision processor has determined that the composite sensor is not in the applied state. The first period is a period in which the decision processor has determined that the composite sensor is in the applied state.

### BRIEF DESCRIPTION OF DRAWINGS

FIG. 1 is a functional block diagram illustrating a logical configuration for a composite sensor according to a first embodiment;

FIG. 2 is a functional block diagram illustrating a logical configuration for a decision processor included in the composite sensor;

FIG. 3 is a flowchart showing how a control circuit operates in the composite sensor;

FIG. 4 is a flowchart showing how the control circuit operates in the composite sensor in an applied state;

FIG. 5 is a flowchart showing how the control circuit operates in the composite sensor in a non-applied state;

FIG. 6A is a graph showing how an angular velocity signal and an angular velocity offset magnitude change with time;

FIG. 6B shows, on a larger scale, a range shown in FIG. 6A where the angular velocity is around zero;

FIG. 7 is a graph showing how a linear acceleration signal, calculated by removing gravitational acceleration from an acceleration signal, and an acceleration offset correction magnitude change with time;

FIG. 8 is a functional block diagram illustrating a logical configuration for a composite sensor according to a first variation of the first embodiment;

FIG. 9 is a functional block diagram illustrating a logical configuration for a decision processor included in the composite sensor;

FIG. 10 is a functional block diagram illustrating a logical configuration for a composite sensor according to a second embodiment;

FIG. 11 is a functional block diagram illustrating a logical configuration for a decision processor included in the composite sensor;

FIG. 12 is a functional block diagram illustrating a logical configuration for an angular velocity averaging unit included in the composite sensor;

FIG. 13 is a graph showing how an angular velocity signal and an angular velocity average signal change with time;

FIG. 14 is a functional block diagram illustrating a logical configuration for a composite sensor according to a third embodiment;

FIG. 15 is a functional block diagram illustrating a logical configuration for a composite sensor according to a first alternative variation;

FIG. 16 is a functional block diagram illustrating a logical configuration for a composite sensor according to a second alternative variation; and

FIG. 17 is a functional block diagram illustrating a logical configuration for a decision processor in a composite sensor according to a fourth alternative variation.

### DESCRIPTION OF EMBODIMENTS

A composite sensor according to an exemplary embodiment will now be described with reference to the accompanying drawings.

### First Embodiment

A composite sensor 1 according to the present disclosure will be described with reference to the accompanying drawings.

### (1) Composite Sensor

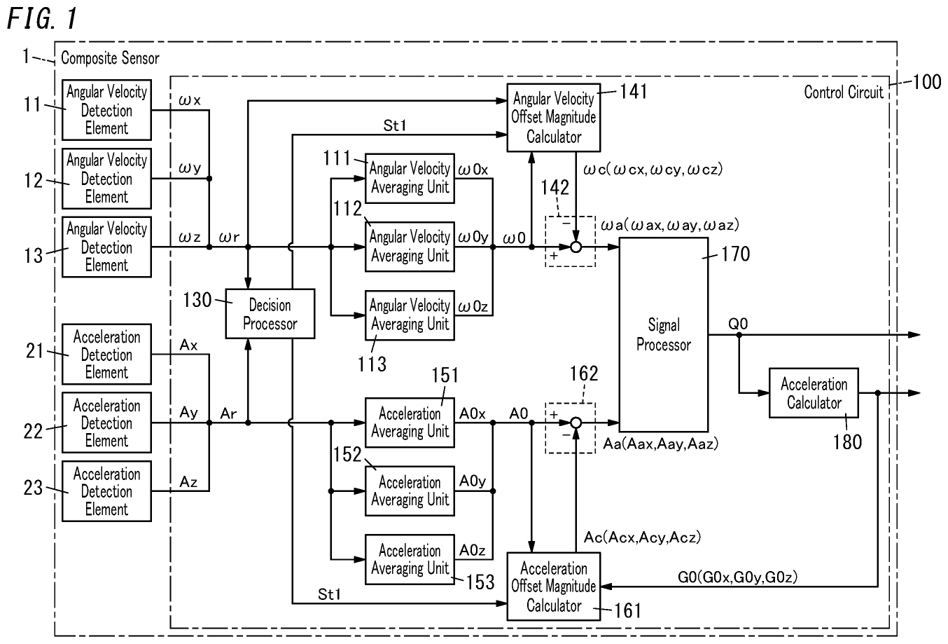

FIG. 1 is a block diagram illustrating a logical configuration for a composite sensor 1 according to a first embodiment. The composite sensor 1 according to the first embodiment includes angular velocity detection elements 11, 12, 13, acceleration detection elements 21, 22, 23, and a control circuit 100.

### (2) Configurations for Angular Velocity Detection Elements and Acceleration Detection Elements

### (2.1) Angular Velocity Detection Elements

Each of the angular velocity detection elements 11-13 is a uniaxial gyrosensor. Each of the angular velocity detection elements 11-13 detects angular velocity around a detection axis. Each of the angular velocity detection elements 11-13 is a so-called “microelectromechanical systems (MEMS) gyrosensor.” Each of the angular velocity detection elements 11-13 may include, for example, a vibrating electrode and a detecting electrode. The vibrating electrode vibrates in a first direction perpendicular to the detection axis. The detecting electrode detects, using capacitance, the movement of the vibrating electrode in a second direction which is perpendicular to both the detection axis and the first direction. Note that each of the angular velocity detection elements 11-13 does not have to have such a structure but may also have any arbitrary structure as long as the angular velocity detection element 11-13 may detect angular velocity around the detection axis.

The directions in which respective detection axes of the angular velocity detection elements 11-13 extend are perpendicular to each other. The detection axes of the angular velocity detection elements 11-13 will be hereinafter referred to as an “x-axis,” a “y-axis,” and a “z-axis,” respectively. The y-axis intersects at right angles with the x-axis. The z-axis intersects at right angles with not only the x-axis but also the y-axis as well.

Each of the angular velocity detection elements 11-13 outputs an angular velocity signal representing angular velocity around the detection axis to the control circuit 100. Specifically, an angular velocity signal output by the angular velocity detection element 11 and representing angular velocity around the x-axis will be hereinafter referred to as an “x-axis angular velocity signal ωx.” An angular velocity signal output by the angular velocity detection element 12 and representing angular velocity around the y-axis will be hereinafter referred to as a “y-axis angular velocity signal ωy.” An angular velocity signal output by the angular velocity detection element 13 and representing angular velocity around the z-axis will be hereinafter referred to as a “z-axis angular velocity signal ωz.” Also, an angular velocity signal as a three-dimensional vector including the x-axis angular velocity signal ωx, the y-axis angular velocity signal ωy, and the z-axis angular velocity signal ωz as respective components will be hereinafter referred to as an “angular velocity signal or.” The x-axis angular velocity signal ωx, the y-axis angular velocity signal ωy, and the z-axis angular velocity signal ωz may be output as, for example, respective voltage values. The absolute value of the x-axis angular velocity signal ωx is the absolute value of the amplitude of the x-axis angular velocity signal ωx and represents the magnitude of the angular velocity. The absolute value of the y-axis angular velocity signal ωy is the absolute value of the amplitude of the y-axis angular velocity signal ωy and represents the magnitude of the angular velocity. The absolute value of the z-axis angular velocity signal ωz is the absolute value of the amplitude of the z-axis angular velocity signal ωz and represents the magnitude of the angular velocity. Also, the sign of each of the x-axis angular velocity signal ωx, the y-axis angular velocity signal ωy, and the z-axis angular velocity signal ωz indicates the direction of rotation with respect to their detection axis. The unit of the angular velocity may be, for example, deg/sec (hereinafter referred to as “dps”). Alternatively, the unit of the angular velocity may also be another unit such as rad/sec indicating the angular velocity.

### (2.2) Acceleration Detection Elements

Each of the acceleration detection elements 21-23 is a uniaxial acceleration sensor. Each of these acceleration detection elements 21-23 may be, for example, a capacitive MEMS sensor. Each of the acceleration detection elements 21-23 may include, for example, a pair of fixed electrodes, a moving electrode, a spindle, and an elastic member. The pair of fixed electrodes face each other in the direction in which the detection axis extends. The moving electrode is located between the fixed electrodes. The spindle is connected to the moving electrode. The elastic member supports the moving electrode in the direction in which the detection axis extends. Note that each of the acceleration detection elements 21-23 does not have to have such a structure but may also have any arbitrary structure as long as the acceleration detection element 21-23 may detect acceleration along the detection axis.

The directions in which respective detection axes of the acceleration detection elements 21-23 extend intersect with each other at right angles. The direction in which the detection axis of each of these acceleration detection elements 21-23 extends is parallel to the direction in which the detection axis of any one of the angular velocity detection elements 11-13 extends. Specifically, the detection axis of the acceleration detection element 21 is the direction in which the x-axis extends. The detection axis of the acceleration detection element 22 is the direction in which the y-axis extends. The detection axis of the acceleration detection element 23 is the direction in which the z-axis extends. These directions in which the x-, y-, and z-axes extend will be hereinafter referred to as an “x-direction,” a “y-direction,” and a “z-direction,” respectively.

Each of the acceleration detection elements 21-23 outputs an acceleration signal, representing the acceleration in the direction aligned with its detection axis, to the control circuit 100. Specifically, an acceleration signal output by the acceleration detection element 21 which represents acceleration in the x-direction will be hereinafter referred to as an “x-axis acceleration signal Ax.” An acceleration signal output by the acceleration detection element 22 which represents acceleration in the y-direction will be hereinafter referred to as a “y-axis acceleration signal Ay.” An acceleration signal output by the acceleration detection element 23 which represents acceleration in the z-direction will be hereinafter referred to as a “z-axis acceleration signal Az.” Also, an acceleration signal as a three-dimensional vector including the x-axis acceleration signal Ax, the y-axis acceleration signal Ay, and the z-axis acceleration signal Az as respective components will be hereinafter referred to as an “acceleration signal Ar.” The x-axis acceleration signal Ax, the y-axis acceleration signal Ay, and the z-axis acceleration signal Az may be output as, for example, respective voltage values. The absolute value of the x-axis acceleration signal Ax is the absolute value of the amplitude of the x-axis acceleration signal Ax and represents the magnitude of the acceleration. The absolute value of the y-axis acceleration signal Ay is the absolute value of the amplitude of the y-axis acceleration signal Ay and represents the magnitude of the acceleration. The absolute value of the z-axis acceleration signal Az is the absolute value of the amplitude of the z-axis acceleration signal Az and represents the magnitude of the acceleration. Also, the sign of each of the x-axis acceleration signal Ax, the y-axis acceleration signal Ay, and the z-axis acceleration signal Az indicates the direction in which the acceleration is applied. The unit of the acceleration may be, for example, m/s². The unit of the acceleration does not have to be m/s² but may also be another unit indicating the acceleration.

### (3) Control Circuit

### (3.1) Overview of Control Circuit

The control circuit 100 acquires the x-axis angular velocity signal ωx, the y-axis angular velocity signal ωy, and the z-axis angular velocity signal ωz from the angular velocity detection elements 11-13, respectively. In addition, the control circuit 100 also acquires the x-axis acceleration signal Ax, the y-axis acceleration signal Ay, and the z-axis acceleration signal Az from the acceleration detection elements 21-23, respectively. Then, the control circuit 100 makes correction to the x-axis angular velocity signal ωx, the y-axis angular velocity signal ωy, the z-axis angular velocity signal ωz, the x-axis acceleration signal Ax, the y-axis acceleration signal Ay, and the z-axis acceleration signal Az. The control circuit 100 also outputs, based on the corrected angular velocity and the corrected acceleration, a quaternion signal representing the posture of the composite sensor 1.

As shown in FIG. 1, the control circuit 100 includes angular velocity averaging units 111, 112, 113, a decision processor 130, an angular velocity offset magnitude calculator 141, and an angular velocity corrector 142. In addition, as shown in FIG. 1, the control circuit 100 further includes acceleration averaging units 151, 152, 153, an acceleration offset magnitude calculator 161, an acceleration corrector 162, a signal processor 170, and an acceleration calculator 180.

The control circuit 100 may be, for example, a single application specific integrated circuit (ASIC). Note that the control circuit 100 does not have to be a single ASIC but may be a circuit including one or more ICs or a microcomputer as well.

### (3.2) Angular Velocity Averaging Units

Each of the angular velocity averaging units 111-113 performs time averaging processing on its corresponding component of the angular velocity signal or.

The angular velocity averaging unit 111 performs time averaging processing on the x-axis angular velocity signal ωx. More specifically, the angular velocity averaging unit 111 repeatedly outputs the average value of the x-axis angular velocity signal ωx per unit time. The unit time may be, for example, 100 ms. That is to say, the angular velocity averaging unit 111 calculates the average value of the x-axis angular velocity signal ωx every 100 ms and outputs the average value thus calculated as an x-axis angular velocity average signal ω0x.

In the same way, the angular velocity averaging unit 112 performs time averaging processing on the y-axis angular velocity signal ωy. More specifically, the angular velocity averaging unit 112 repeatedly outputs the average value of the y-axis angular velocity signal ωy per unit time. The unit time may be, for example, 100 ms. That is to say, the angular velocity averaging unit 112 calculates the average value of the y-axis angular velocity signal ωy every 100 ms and outputs the average value thus calculated as a y-axis angular velocity average signal ω0y.

In the same way, the angular velocity averaging unit 113 performs time averaging processing on the z-axis angular velocity signal ωz. More specifically, the angular velocity averaging unit 113 repeatedly outputs the average value of the z-axis angular velocity signal ωz per unit time. The unit time may be, for example, 100 ms. That is to say, the angular velocity averaging unit 113 calculates the average value of the z-axis angular velocity signal ωz every 100 ms and outputs the average value thus calculated as a z-axis angular velocity average signal ω0z.

An angular velocity average signal as a three-dimensional vector including the x-axis angular velocity average signal ω0x, the y-axis angular velocity average signal ω0y, and the z-axis angular velocity average signal ω0z as respective components will be hereinafter referred to as an “angular velocity average signal ω0.”

### (3.3) Decision Processor

The decision processor 130 is a circuit for determining whether angular velocity and linear acceleration are applied to the composite sensor 1.

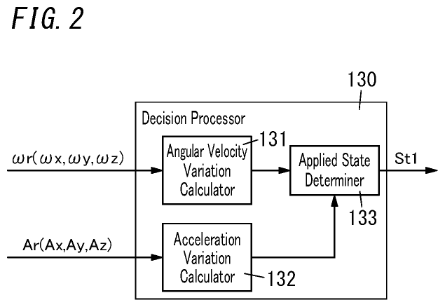

FIG. 2 is a block diagram of the decision processor 130. As shown in FIG. 2, the decision processor 130 includes an angular velocity variation calculator 131, an acceleration variation calculator 132, and an applied state determiner 133.

### (3.3.1) Angular Velocity Variation Calculator

The angular velocity variation calculator 131 calculates an angular velocity parameter indicating whether angular velocity is applied to the composite sensor 1. The angular velocity parameter may be, for example, a squared variance of variations with time in the respective components of the angular velocity signal or (namely, the x-axis angular velocity signal ωx, the y-axis angular velocity signal ωy, and the z-axis angular velocity signal ωz). The variation with time of the x-axis angular velocity signal ωx may be, for example, a value calculated by dividing the variation per unit time of the x-axis angular velocity signal ωx by the unit time. That is to say, the angular velocity parameter is obtained by dividing the variation per unit time by the unit time with respect to each of the x-axis angular velocity signal ωx, the y-axis angular velocity signal oy, and the z-axis angular velocity signal ωz and by adding together the respective squares of the quotients thus calculated. For example, if the unit time is 3 ms, the angular velocity variation calculator 131 acquires the x-axis angular velocity signal ωx, the y-axis angular velocity signal ωy, and the z-axis angular velocity signal ωz every 3 ms. The angular velocity variation calculator 131 divides, for example, the variation of the current level of the x-axis angular velocity signal ωx with respect to the previous level of the x-axis angular velocity signal ωx 3 ms ago by 3 ms and holds the quotient thus calculated as the variation with time of the x-axis angular velocity signal ox. In the same way, the angular velocity variation calculator 131 divides, for example, the variation in the current level of the y-axis angular velocity signal ωy with respect to the previous level of the y-axis angular velocity signal ωy 3 ms ago by 3 ms and holds the quotient thus calculated as the variation with time of the y-axis angular velocity signal ωy. In the same way, the angular velocity variation calculator 131 divides, for example, the variation of the current level of the z-axis angular velocity signal ωz with respect to the previous level of the z-axis angular velocity signal ωz 3 ms ago by 3 ms and holds the quotient thus calculated as the variation with time of the z-axis angular velocity signal ωz. Then, the angular velocity variation calculator 131 calculates, as an angular velocity parameter, the sum of the square of the variation with time of the x-axis angular velocity signal ωx, the square of the variation with time of the y-axis angular velocity signal ωy, and the square of the variation with time of the z-axis angular velocity signal ωz. For example, if the unit of the respective components of the angular velocity signal or is dps, then the unit of the variations with time in the respective components of the angular velocity signal or may be, for example, dps/s and the unit of the angular velocity parameter may be, for example, (dps/s)².

### (3.3.2) Acceleration Variation Calculator

The acceleration variation calculator 132 calculates an acceleration parameter indicating whether acceleration is applied to the composite sensor 1. The acceleration parameter may be, for example, a squared variance of variations with time in the respective components of the acceleration signal Ar (namely, the x-axis acceleration signal Ax, the y-axis acceleration signal Ay, and the z-axis acceleration signal Az). The variation with time of the x-axis acceleration signal Ax may be, for example, a value calculated by dividing the variation per unit time of the x-axis acceleration signal Ax by the unit time. That is to say, the acceleration parameter is obtained by dividing the variation per unit time by the unit time with respect to each of the x-axis acceleration signal Ax, the y-axis acceleration signal Ay, and the z-axis acceleration signal Az and by adding together the respective squares of the quotients thus calculated. For example, if the unit time is 3 ms, the acceleration variation calculator 132 acquires the x-axis acceleration signal Ax, the y-axis acceleration signal Ay, and the z-axis acceleration signal Az every 3 ms. The acceleration variation calculator 132 divides, for example, the variation of the current level of the x-axis acceleration signal Ax with respect to the previous level of the x-axis acceleration signal Ax 3 ms ago by 3 ms and holds the quotient thus calculated as the variation with time of the x-axis acceleration signal Ax. In the same way, the acceleration variation calculator 132 divides, for example, the variation of the current level of the y-axis acceleration signal Ay with respect to the previous level of the y-axis acceleration signal Ay 3 ms ago by 3 ms and holds the quotient thus calculated as the variation with time of the y-axis acceleration signal Ay. In the same way, the acceleration variation calculator 132 divides, for example, the variation of the current level of the z-axis acceleration signal Az with respect to the previous level of the z-axis acceleration signal Az 3 ms ago by 3 ms and holds the quotient thus calculated as the variation with time of the z-axis acceleration signal Az. Then, the acceleration variation calculator 132 calculates, as an acceleration parameter, the sum of the square of the variation with time of the x-axis acceleration signal Ax, the square of the variation with time of the y-axis acceleration signal Ay, and the square of the variation with time of the z-axis acceleration signal Az. For example, if the unit of the respective components of the acceleration signal Ar is m/s², then the unit of the variations with time in the respective components of the acceleration signal Ar may be, for example, m/s²/s and the unit of the acceleration parameter may be, for example, (m/s²/s)².

### (3.3.3) Applied State Determiner

The applied state determiner 133 determines whether angular velocity and linear acceleration are applied to the composite sensor 1. As used herein, the “linear acceleration” refers to the rest of the acceleration applied to the composite sensor 1 other than the gravitational acceleration.

Specifically, the applied state determiner 133 determines, based on the angular velocity parameter and the acceleration parameter, whether angular velocity and linear acceleration are applied to the composite sensor 1. A state where at least one of angular velocity or linear acceleration is applied to the composite sensor 1 will be hereinafter referred to as an “applied state.”

The applied state determiner 133 determines each of a state where the angular velocity parameter is greater than an angular velocity variance threshold value and a state where the acceleration parameter is greater than an acceleration variance threshold value to be the applied state. In other words, the applied state determiner 133 determines a state where the angular velocity parameter is equal to or less than the angular velocity variance threshold value and the acceleration parameter is equal to or less than the acceleration variance threshold value to be the non-applied state. The angular velocity variance threshold value may be, for example, 0.0001 (dps/s)². The acceleration variance threshold value may be, for example, 0.0001 (m/s²/s)².

The applied state determiner 133 repeatedly determines, at predetermined intervals, whether the composite sensor 1 is in the applied state. The predetermined interval may be, for example, 3 ms. In addition, the applied state determiner 133 also outputs, at predetermined intervals, the decision result as an applied state signal St1. The applied state signal St1 is a signal indicating whether the composite sensor 1 is in the applied state or not.

In the following description, a period in which the applied state determiner 133 determines that the composite sensor 1 is in the applied state will be hereinafter referred to as a “first period” and a period in which the applied state determiner 133 determines that the composite sensor 1 is in the non-applied state will be hereinafter referred to as a “second period.” For example, if the composite sensor 1 is in a state where neither angular velocity nor linear acceleration is applied thereto, then the applied state determiner 133 determines that the composite sensor 1 is in the non-applied state. A period in which the composite sensor 1 is in the non-applied state is the second period. Also, when linear acceleration is applied to the composite sensor 1 after that, the applied state determiner 133 determines that the composite sensor 1 is in the applied state. That is to say, when the linear acceleration applied to the composite sensor 1 is no longer equal to zero, the second period ends and the first period begins. Furthermore, when the linear acceleration applied to the composite sensor 1 goes zero after that, the applied state determiner 133 determines that the composite sensor 1 is in the non-applied state. That is to say, when the linear acceleration applied to the composite sensor 1 goes zero, the first period ends and the second period begins.

### (3.4) Angular Velocity Offset Magnitude Calculator

The angular velocity offset magnitude calculator 141 outputs, in accordance with the applied state signal St1 supplied from the decision processor 130, an angular velocity correction signal ωc for making an offset correction to the angular velocity average signal ω0. The angular velocity correction signal ωc is a three-dimensional vector including, as respective components, an x-axis angular velocity correction signal ωcx, a y-axis angular velocity correction signal ωcy, and a z-axis angular velocity correction signal ωcz. The x-axis angular velocity correction signal ωcx indicates the magnitude of offset with respect to the x-axis angular velocity average signal ω0x. The y-axis angular velocity correction signal ωcy indicates the magnitude of offset with respect to the y-axis angular velocity average signal ω0y. The z-axis angular velocity correction signal ωcz indicates the magnitude of offset with respect to the z-axis angular velocity average signal ω0z.

The angular velocity offset magnitude calculator 141 acquires the angular velocity signal or from the angular velocity detection elements 11-13. In addition, the angular velocity offset magnitude calculator 141 also acquires the angular velocity average signal ω0 from the angular velocity averaging units 111-113.

If the applied state signal St1 indicates that the composite sensor 1 is in the non-applied state, the angular velocity offset magnitude calculator 141 outputs the angular velocity average signal ω0 as the angular velocity correction signal ωc. That is to say, the x-axis angular velocity correction signal ωcx is the same as the x-axis angular velocity average signal ω0x. The y-axis angular velocity correction signal ωcy is the same as the y-axis angular velocity average signal ω0y. The z-axis angular velocity correction signal ωcz is the same as the z-axis angular velocity average signal ω0z. If the applied state signal St1 indicates that the composite sensor 1 is in the non-applied state, then no angular velocity is being applied to the composite sensor 1. Thus, the angular velocity average signal ω0 is used as it is as the angular velocity correction signal ωc. As a result, the angular velocity average signal ω0 is subjected to offset correction using the angular velocity average signal ω0, and the angular velocity goes zero after the offset correction.

In addition, the angular velocity offset magnitude calculator 141 calculates the time averages of the respective components of the angular velocity signal or in the second period and holds the time averages thus calculated as an applied state angular velocity offset magnitude od. As used herein, the applied state angular velocity offset magnitude od is a three-dimensional vector including, as respective components, the average of the x-axis angular velocity signal ωx over the second period, the average of the y-axis angular velocity signal ωy over the second period, and the average of the z-axis angular velocity signal ωz over the second period. Then, when the state indicated by the applied state signal St1 changes from the non-applied state into the applied state, the angular velocity offset magnitude calculator 141 outputs, in the first period that has begun, the applied state angular velocity offset magnitude od that has been calculated in the previous second period as the angular velocity correction signal ωc. That is to say, when the decision processor 130 determines that the composite sensor 1 is in the applied state, the angular velocity offset magnitude calculator 141 regards the average of the x-axis angular velocity signal ωx over the previous second period as the x-axis angular velocity correction signal ωcx. In the same way, the angular velocity offset magnitude calculator 141 regards, in the first period, the average of the y-axis angular velocity signal ωy over the previous second period as the y-axis angular velocity correction signal ωcy. In the same way, the angular velocity offset magnitude calculator 141 regards, in the first period, the average of the z-axis angular velocity signal ωz over the previous second period as the z-axis angular velocity correction signal ωcz.

The angular velocity offset magnitude calculator 141 holds the x-axis angular velocity signal ωx during the second period, for example. Then, when the state indicated by the applied state signal St1 changes from the non-applied state into the applied state, the angular velocity offset magnitude calculator 141 calculates the time average of the x-axis angular velocity signal ωx that has been held during the second period and regards the time average as the x-axis angular velocity correction signal ωcx. In the same way, the angular velocity offset magnitude calculator 141 regards the time average of the y-axis angular velocity signal ωy over the second period as the y-axis angular velocity correction signal ωcy. In the same way, the angular velocity offset magnitude calculator 141 regards the time average of the z-axis angular velocity signal ωz over the second period as the z-axis angular velocity correction signal ωcz.

When the state indicated by the applied state signal St1 changes from the applied state into the non-applied state, the angular velocity offset magnitude calculator 141 resets the applied state angular velocity offset magnitude od that has been held and outputs the angular velocity average signal ω0 as the angular velocity correction signal ωc. Then, the angular velocity offset magnitude calculator 141 holds an applied state angular velocity offset magnitude od, of which the components are respective time averages of the x-axis angular velocity signal ωx, the y-axis angular velocity signal ωy, and the z-axis angular velocity signal ωz over a new second period. This processing allows, even if the offset magnitude varies due to either an environmental change such as a temperature variation or some change involved with the passage of time, the angular velocity correction signal ωc over the first period to be output based on the angular velocity signal or over the previous second period. This allows the angular velocity offset magnitude calculator 141 to always output an appropriate angular velocity correction signal ωc.

### (3.5) Angular Velocity Corrector

The angular velocity corrector 142 generates a corrected angular velocity signal ωa by adding the angular velocity correction signal ωc, supplied from the angular velocity offset magnitude calculator 141, to the angular velocity average signal ω0 supplied from the angular velocity averaging units 111-113. The corrected angular velocity signal ωa is a three-dimensional vector including, as respective components, an x-axis corrected angular velocity signal ωax, a y-axis corrected angular velocity signal ωay, and a z-axis corrected angular velocity signal ωaz.

The angular velocity corrector 142 generates the x-axis corrected angular velocity signal ωax by subtracting the x-axis angular velocity correction signal ωcx from the x-axis angular velocity average signal ωx. In addition, the angular velocity corrector 142 also generates the y-axis corrected angular velocity signal ωay by subtracting the y-axis angular velocity correction signal ωcy from the y-axis angular velocity average signal ωy. Furthermore, the angular velocity corrector 142 generates the z-axis corrected angular velocity signal ωaz by subtracting the z-axis angular velocity correction signal ωcz from the z-axis angular velocity average signal ω0z.

### (3.6) Acceleration Averaging Units

Each of the acceleration averaging units 151-153 performs time averaging processing on its corresponding component of the acceleration signal Ar.

The acceleration averaging unit 151 repeatedly outputs the average value of the x-axis acceleration signal Ax per unit time. The unit time may be, for example, 100 ms. That is to say, the acceleration averaging unit 151 calculates the average value of the x-axis acceleration signal Ax every 100 ms and outputs the average value thus calculated as an x-axis acceleration average signal A0x.

In the same way, the acceleration averaging unit 152 repeatedly outputs the average value of the y-axis acceleration signal Ay per unit time. The unit time may be, for example, 100 ms. That is to say, the acceleration averaging unit 152 calculates the average value of the y-axis acceleration signal Ay every 100 ms and outputs the average value thus calculated as a y-axis acceleration average signal A0y.

In the same way, the acceleration averaging unit 153 repeatedly outputs the average value of the z-axis acceleration signal Az per unit time. The unit time may be, for example, 100 ms. That is to say, the acceleration averaging unit 153 calculates the average value of the z-axis acceleration signal Az every 100 ms and outputs the average value thus calculated as a z-axis acceleration average signal A0z.

An acceleration average signal as a three-dimensional vector including the x-axis acceleration average signal A0x, the y-axis acceleration average signal A0y, and the z-axis acceleration average signal A0z as respective components will be hereinafter referred to as an “acceleration average signal A0.”

### (3.7) Acceleration Offset Magnitude Calculator

The acceleration offset magnitude calculator 161 outputs, in accordance with the applied state signal St1 supplied from the decision processor 130, an acceleration correction signal Ac for making an offset correction to the acceleration average signal A0. The acceleration correction signal Ac is a three-dimensional vector including, as respective components, an x-axis acceleration correction signal Acx, a y-axis acceleration correction signal Acy, and a z-axis acceleration correction signal Acz. The x-axis acceleration correction signal Acx indicates the magnitude of acceleration offset with respect to the x-axis acceleration average signal A0x. The y-axis acceleration correction signal Acy indicates the magnitude of acceleration offset with respect to the y-axis acceleration average signal A0y. The z-axis acceleration correction signal Acz indicates the magnitude of acceleration offset with respect to the z-axis acceleration average signal A0z.

The acceleration offset magnitude calculator 161 acquires the acceleration average signal A0 from the acceleration averaging units 151-153. In addition, the acceleration offset magnitude calculator 161 also acquires a gravitational acceleration signal G0 from an acceleration calculator 180. The gravitational acceleration signal G0 is a three-dimensional vector including, as respective components, an x-axis gravitational acceleration signal G0x, a y-axis gravitational acceleration signal G0y, and a z-axis gravitational acceleration signal G0z as will be described later.

If the applied state signal St1 indicates that the composite sensor 1 is in the non-applied state, the acceleration offset magnitude calculator 161 calculates the magnitude of acceleration offset to be zero with respect to any one of the x-axis acceleration average signal A0x, the y-axis acceleration average signal A0y, and the z-axis acceleration average signal A0z. That is to say, the acceleration offset magnitude calculator 161 outputs an acceleration correction signal Ac in which the x-axis acceleration correction signal Acx, the y-axis acceleration correction signal Acy, and the z-axis acceleration correction signal Acz are all equal to zero.

In addition, the acceleration offset magnitude calculator 161 also calculates, based on the x-axis acceleration average signal A0x, the y-axis acceleration average signal A0y, the z-axis acceleration average signal A0z, and the gravitational acceleration signal G0, an applied state acceleration offset magnitude Ld in the second period. The applied state acceleration offset magnitude Ld is the average of the linear acceleration signal in the second period. The linear acceleration signal is a three-dimensional vector including, as respective components, the x-axis linear acceleration signal, the y-axis linear acceleration signal, and the z-axis linear acceleration signal. The x-axis linear acceleration signal is obtained by subtracting the x-axis gravitational acceleration signal G0x from the x-axis acceleration average signal A0x. The y-axis linear acceleration signal is obtained by subtracting the y-axis gravitational acceleration signal G0y from the y-axis acceleration average signal A0y. The z-axis linear acceleration signal is obtained by subtracting the z-axis gravitational acceleration signal G0z from the z-axis acceleration average signal A0z. That is to say, the applied state acceleration offset magnitude Ld is a three-dimensional vector including, as respective components, the average of the x-axis linear acceleration signal over the second period, the average of the y-axis linear acceleration signal over the second period, and the average of the z-axis linear acceleration signal over the second period.

If the applied state signal St1 indicates that the composite sensor 1 is in the applied state, the acceleration offset magnitude calculator 161 outputs, as the acceleration correction signal Ac, the applied state acceleration offset magnitude Ld in the previous second period. That is to say, if the applied state signal St1 indicates that the composite sensor 1 is in the applied state, the x-axis acceleration correction signal Acx is the average value of the x-axis linear acceleration signal over the previous second period. In the same way, in the first period, the y-axis acceleration correction signal Acy is the average value of the y-axis linear acceleration signal over the previous second period. In the same way, in the first period, the z-axis acceleration correction signal Acz is the average value of the z-axis linear acceleration signal over the previous second period. The acceleration offset magnitude calculator 161 holds, in the second period, for example, the applied state acceleration offset magnitude Ld including, as respective components, the x-axis linear acceleration signal, the y-axis linear acceleration signal, the z-axis linear acceleration signal, and their respective average values.

When the state indicated by the applied state signal St1 changes from the applied state into the non-applied state, the acceleration offset magnitude calculator 161 resets the applied state acceleration offset magnitude Ld that has been held and outputs the acceleration correction signal Ac, of which all components are zero. Then, the acceleration offset magnitude calculator 161 holds an applied state acceleration offset magnitude Ld, of which the components are respective time averages of the x-axis linear acceleration signal, the y-axis linear acceleration signal, and the z-axis linear acceleration signal over a new second period. This processing allows, even if the offset magnitude varies due to either an environmental change such as a temperature variation or some change involved with the passage of time, the acceleration correction signal Ac in the first period to be output based on the acceleration average signal A0 and the gravitational acceleration signal G0 in the previous second period. This allows the acceleration offset magnitude calculator 161 to always output an appropriate acceleration correction signal Ac.

### (3.8) Acceleration Corrector

The acceleration corrector 162 generates a corrected acceleration signal Aa by adding the acceleration correction signal Ac, supplied from the acceleration offset magnitude calculator 161, to the acceleration average signal A0 supplied from the acceleration averaging units 151-153. The corrected acceleration signal Aa is a three-dimensional vector including, as respective components, an x-axis corrected acceleration signal Aax, a y-axis corrected acceleration signal Aay, and a z-axis corrected acceleration signal Aaz.

The acceleration corrector 162 generates the x-axis corrected acceleration signal Aax by subtracting the x-axis acceleration correction signal Acx from the x-axis acceleration average signal A0x. In addition, the acceleration corrector 162 also generates the y-axis corrected acceleration signal Aay by subtracting the y-axis acceleration correction signal Acy from the y-axis acceleration average signal A0y. Furthermore, the acceleration corrector 162 generates the z-axis corrected acceleration signal Aaz by subtracting the z-axis acceleration correction signal Acz from the z-axis acceleration average signal A0z.

### (3.9) Signal Processor

The signal processor 170 predicts, based on the corrected angular velocity signal ωa supplied from the angular velocity corrector 142 and the corrected acceleration signal Aa supplied from the acceleration corrector 162, the posture of the composite sensor 1, thereby outputting a quaternion signal Q0.

The signal processor 170 predicts the posture of the composite sensor 1 using an extended Kalman filter, for example. The signal processor 170 predicts the current state of the composite sensor 1 using the previous estimated state and a state equation in a state space model, for example. Then, the signal processor 170 estimates the current posture of the composite sensor 1 by performing update processing using the difference between the prediction-based angular velocity and acceleration and the corrected angular velocity signal ωa and the corrected acceleration signal Aa. The current posture of the composite sensor 1 is indicated by the quaternion signal Q0.

Note that the signal processor 170 does not have to use the extended Kalman filter to calculate the posture of the composite sensor 1. Alternatively, the signal processor 170 may also calculate the posture of the composite sensor 1 using an unscented Kalman filter (UKF), a complementary filter, or a Madgwick filter, for example. The signal processor 170 calculates or predicts, based on the corrected angular velocity signal ωa and the corrected acceleration signal Aa, the posture of the composite sensor 1 to output a quaternion signal Q0 representing the posture of the composite sensor 1.

### (3.10) Acceleration Calculator

The acceleration calculator 180 outputs, based on the quaternion signal Q0, a gravitational acceleration signal G0 representing the gravitational acceleration to be applied to the composite sensor 1. The gravitational acceleration signal G0 is a three-dimensional vector including, as respective components, an x-axis gravitational acceleration signal G0x representing the x-axis component of the gravitational acceleration, a y-axis gravitational acceleration signal G0y representing the y-axis component of the gravitational acceleration, and a z-axis gravitational acceleration signal G0z representing the z-axis component of the gravitational acceleration.

The acceleration calculator 180 calculates, based on the posture of the composite sensor 1 represented by the quaternion signal Q0, a vector representing the gravitational acceleration in an xyz coordinate system that uses, as reference axes, the respective detection axes of the acceleration detection elements 21-23. A vector representing the gravitational acceleration is a vector, which is directed vertically downward and of which the magnitude is the gravitational acceleration (1 G≅approximately 9.80665 m/s²). Then, the acceleration calculator 180 calculates the x-, y-, and z-components of the vector representing the gravitational acceleration as the x-axis component, y-axis component, and z-axis component of the gravitational acceleration. The acceleration calculator 180 outputs the gravitational acceleration signal G0 including, as respective components, the x-axis gravitational acceleration signal G0x representing the x-axis component of the gravitational acceleration, the y-axis gravitational acceleration signal G0y representing the y-axis component of the gravitational acceleration, and the z-axis gravitational acceleration signal G0z representing the z-axis component of the gravitational acceleration.

### (4) Operation

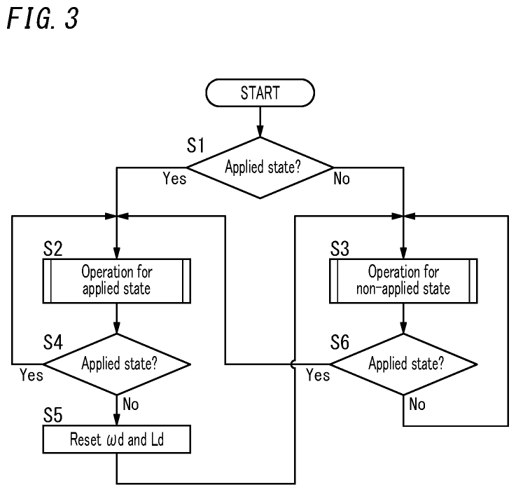

FIG. 3 is a flowchart showing how the control circuit 100 according to the first embodiment operates.

The decision processor 130 of the control circuit 100 determines whether the composite sensor 1 is in the applied state or not (in Step S1). As described above, the decision processor 130 determines the state where the squared variance of the variation with time of angular velocity is greater than the angular velocity variance threshold value and the state where the squared variance of the variation with time of acceleration is greater than the acceleration variance threshold value to be the applied state. Otherwise (i.e., unless the conditions on which the composite sensor 1 is determined to be in the applied state are satisfied), the decision processor 130 determines that the composite sensor 1 is in the non-applied state.

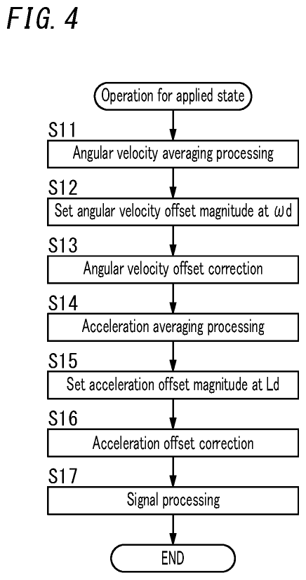

If the decision processor 130 has determined that the composite sensor 1 is in the applied state (if the answer is YES in Step S1), then the control circuit 100 performs Step S2, which is the operation to be performed in the applied state. FIG. 4 is a flowchart showing a detailed operation (Step S2) of the control circuit 100 in a situation where the composite sensor 1 is in the applied state. That is to say, Step S2 includes Steps S11-S17 shown in FIG. 4.

The angular velocity averaging units 111-113 of the control circuit 100 perform time averaging processing on the respective components of the angular velocity signal or supplied from the angular velocity detection elements 11-13, thereby outputting an angular velocity average signal ω0 (in Step S11). The angular velocity averaging unit 111 calculates the time average of the x-axis angular velocity signal ωx as the x-axis angular velocity average signal ω0x. The angular velocity averaging unit 112 calculates the time average of the y-axis angular velocity signal ωy as the y-axis angular velocity average signal ω0y. The angular velocity averaging unit 113 calculates the time average of the z-axis angular velocity signal ωz as the z-axis angular velocity average signal ω0z.

The angular velocity offset magnitude calculator 141 of the control circuit 100 outputs, as the angular velocity correction signal ωc, the applied state angular velocity offset magnitude od that has been generated and held during the previous second period (in Step S12). The processing of generating and holding the applied state angular velocity offset magnitude od will be described later.

The angular velocity corrector 142 of the control circuit 100 adds the angular velocity correction signal ωc to the angular velocity average signal ω0 to output the corrected angular velocity signal ωa (in Step S13).

The acceleration averaging units 151-153 of the control circuit 100 perform time averaging processing on the respective components of the acceleration signal Ar supplied from the acceleration detection elements 21-23 to output the acceleration average signal A0 (in Step S14). The acceleration averaging unit 151 calculates the time average of the x-axis acceleration signal Ax as the x-axis acceleration average signal A0x. The acceleration averaging unit 152 calculates the time average of the y-axis acceleration signal Ay as the y-axis acceleration average signal A0y. The acceleration averaging unit 153 calculates the time average of the z-axis acceleration signal Az as the z-axis acceleration average signal A0z.

The acceleration offset magnitude calculator 161 of the control circuit 100 outputs, as the acceleration correction signal Ac, the applied state acceleration offset magnitude Ld that has been generated and held during the second period (in Step S15). The processing of generating and holding the applied state acceleration offset magnitude Ld will be described later.

The acceleration corrector 162 of the control circuit 100 adds the acceleration correction signal Ac to the acceleration average signal A0 to output the corrected acceleration signal Aa (in Step S16).

The signal processor 170 of the control circuit 100 calculates, based on the corrected angular velocity signal ωa and the corrected acceleration signal Aa, the posture of the composite sensor 1 to output the quaternion signal Q0 (in Step S17). The signal processor 170 predicts, using an extended Kalman filter, for example, the posture of the composite sensor 1 based on the corrected angular velocity signal ωa and the corrected acceleration signal Aa to output a quaternion signal Q0 representing the posture of the composite sensor 1.

The control circuit 100 finishes Step S2 by performing these process steps.

Referring back to FIG. 3, next, the decision processor 130 of the control circuit 100 determines once again whether the composite sensor 1 is in the applied state (in Step S4). A detailed description thereof will be omitted herein because Step S4 is the same as Step S1. If the decision processor 130 has determined that the composite sensor 1 is in the applied state (if the answer is YES in Step S4), the control circuit 100 determines that the first period have still continued and performs Step S2 once again. On the other hand, if the decision processor 130 has determined that the composite sensor 1 is in the non-applied state (if the answer is NO in Step S4), then the control circuit 100 determines that the first period have ended and the second period have begun and resets the applied state angular velocity offset magnitude od and the applied state acceleration offset magnitude Ld (in Step S5). After having performed Step S5, the control circuit 100 starts performing Step S3, which is a processing step to be performed in the non-applied state.

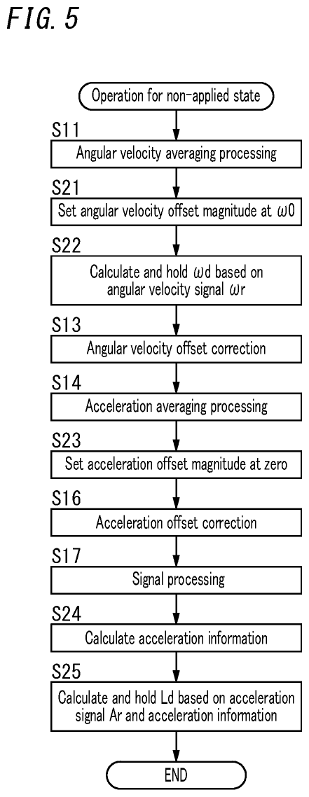

Next, Step S3 which is a processing step that the control circuit 100 performs when the composite sensor 1 is in the non-applied state will be described. FIG. 5 is a flowchart showing detailed processing steps (included in Step S3) to be performed by the control circuit 100 when the composite sensor 1 is in the non-applied state. That is to say, Step S3 includes Steps S11-S25 shown in FIG. 5.

The angular velocity averaging units 111-113 of the control circuit 100 perform time averaging processing on the respective components of the angular velocity signal or supplied from the angular velocity detection elements 11-13, thereby outputting an angular velocity average signal ω0 (in Step S11).

The angular velocity offset magnitude calculator 141 of the control circuit 100 outputs the angular velocity average signal ω0 as the angular velocity correction signal ωc (in Step S21). That is to say, the angular velocity correction signal ωc includes, as respective components thereof, the x-axis angular velocity average signal ω0x, the y-axis angular velocity average signal ω0y, and the z-axis angular velocity average signal ω0z supplied from the angular velocity averaging units 111-113, respectively.

The angular velocity offset magnitude calculator 141 of the control circuit 100 calculates the averages of the respective components of the angular velocity signal or over the second period and holds an applied state angular velocity offset magnitude od including the average values thus calculated as respective components thereof (in Step S22). For example, the angular velocity offset magnitude calculator 141 holds, in a buffer memory, all of the x-axis angular velocity signal ox, the y-axis angular velocity signal ωy, and the z-axis angular velocity signal ωz over the second period. The angular velocity offset magnitude calculator 141 calculates the respective time averages of the x-axis angular velocity signal ωx, the y-axis angular velocity signal ωy, and the z-axis angular velocity signal ωz and holds an applied state angular velocity offset magnitude od including these time averages as respective components thereof. For example, every time the angular velocity signal or is output from the angular velocity detection elements 11-13, the angular velocity offset magnitude calculator 141 holds the x-axis angular velocity signal ωx, the y-axis angular velocity signal ωy, and the z-axis angular velocity signal ωz as additional data in the buffer memory. In addition, the angular velocity offset magnitude calculator 141 calculates again the respective time averages of the x-axis angular velocity signal ωx, the y-axis angular velocity signal ωy, and the z-axis angular velocity signal ωz from the beginning of the second period through the present and updates and holds the applied state angular velocity offset magnitude od.

Alternatively, in Step S22, the angular velocity offset magnitude calculator 141 may also operate in the following manner. The angular velocity offset magnitude calculator 141 may hold, for example, the time length of the second period and the applied state angular velocity offset magnitude od, of which the components are respective time averages of the x-axis angular velocity signal ωx, the y-axis angular velocity signal ωy, and the z-axis angular velocity signal ωz since the beginning of the second period. The angular velocity offset magnitude calculator 141 may update, every time the angular velocity signal or is supplied from the angular velocity detection elements 11-13, for example, the time length of the second period and the applied state angular velocity offset magnitude od into latest values. The angular velocity offset magnitude calculator 141 recalculates the time length of the second period and the applied state angular velocity offset magnitude od based on the x-axis angular velocity signal ωx, the y-axis angular velocity signal oy, the z-axis angular velocity signal ωz, and the time length of the second period and the applied state angular velocity offset magnitude od that are held therein.

Still alternatively, in Step S22, the angular velocity offset magnitude calculator 141 may also operate in the following manner. The angular velocity offset magnitude calculator 141 calculates, in the second period, the time averages of respective components of the angular velocity signal or over a predetermined time length measured retroactively from the present time and holds the applied state angular velocity offset magnitude od, of which the components are those time averages. The predetermined time length may be 3 seconds, for example. In that case, the angular velocity offset magnitude calculator 141 calculates, every time the angular velocity signal or is supplied in the second period from the angular velocity detection element 11, for example, the time average of the angular velocity signal or over the last 3 seconds, and updates and holds the applied state angular velocity offset magnitude od.

The angular velocity corrector 142 of the control circuit 100 adds the angular velocity correction signal ωc to the angular velocity average signal ω0 to output a corrected angular velocity signal ωa (in Step S13).

The acceleration averaging units 151-153 of the control circuit 100 perform time averaging processing on the respective components of the acceleration signal Ar supplied from the acceleration detection elements 21-23 to output an acceleration average signal A0 (in Step S14).

The acceleration offset magnitude calculator 161 of the control circuit 100 outputs an acceleration correction signal Ac, of which all components are zero (in Step S23).

The acceleration corrector 162 of the control circuit 100 adds the acceleration correction signal Ac to the acceleration average signal A0 to output a corrected acceleration signal Aa (in Step S16).

The signal processor 170 of the control circuit 100 predicts the posture of the composite sensor 1 based on the corrected angular velocity signal ωa and the corrected acceleration signal Aa, thereby generating a quaternion signal Q0 (in Step S17).

The acceleration calculator 180 of the control circuit 100 calculates acceleration information based on the quaternion signal Q0 (in Step S24). The acceleration calculator 180 calculates, based on the posture of the composite sensor 1 as represented by the quaternion signal Q0, the x-, y-, and z-axis components of the gravitational acceleration. The acceleration calculator 180 outputs a gravitational acceleration signal G0 as acceleration information. The gravitational acceleration signal G0 includes, as respective components thereof, an x-axis gravitational acceleration signal G0x representing the x-axis component of the gravitational acceleration, a y-axis gravitational acceleration signal G0y representing the y-axis component of the gravitational acceleration, and a z-axis gravitational acceleration signal G0z representing the z-axis component of the gravitational acceleration.

The acceleration offset magnitude calculator 161 of the control circuit 100 calculates the average of the linear acceleration signal L0 for the second period and holds the average as an applied state acceleration offset magnitude Ld (in Step S25).

The acceleration offset magnitude calculator 161 calculates a linear acceleration signal based on the acceleration average signal A0 and the gravitational acceleration signal G0 as the acceleration information. The acceleration offset magnitude calculator 161 calculates the linear acceleration signal by subtracting corresponding components of the gravitational acceleration signal G0 from the respective components of the acceleration average signal A0. Specifically, the acceleration offset magnitude calculator 161 calculates an x-axis linear acceleration signal by subtracting the x-axis gravitational acceleration signal G0x from the x-axis acceleration average signal A0x. The acceleration offset magnitude calculator 161 calculates a y-axis linear acceleration signal by subtracting the y-axis gravitational acceleration signal G0y from the y-axis acceleration average signal A0y. The acceleration offset magnitude calculator 161 calculates a z-axis linear acceleration signal by subtracting the z-axis gravitational acceleration signal G0z from the z-axis acceleration average signal A0z.

The acceleration offset magnitude calculator 161 holds, for example, all of the x-axis linear acceleration signal, the y-axis linear acceleration signal, and the z-axis linear acceleration signal for the second period in a buffer memory. Then, the acceleration offset magnitude calculator 161 calculates the respective time averages of the x-axis linear acceleration signal, the y-axis linear acceleration signal, and the z-axis linear acceleration signal and holds an applied state acceleration offset magnitude Ld, of which the components are the time averages thus calculated. The acceleration offset magnitude calculator 161 calculates, every time the acceleration average signal A0 is supplied from the acceleration averaging units 151-153, the x-axis linear acceleration signal, the y-axis linear acceleration signal, and the z-axis linear acceleration signal and holds the x-axis linear acceleration signal, the y-axis linear acceleration signal, and the z-axis linear acceleration signal thus calculated as additional data in the buffer memory. In addition, the acceleration offset magnitude calculator 161 recalculates the respective time averages of the x-axis linear acceleration signal, the y-axis linear acceleration signal, and the z-axis linear acceleration signal over a period from the beginning of the second period through the present time and updates and holds the applied state acceleration offset magnitude Ld.

Alternatively, in Step S25, the acceleration offset magnitude calculator 161 may also operate in the following manner. For example, the acceleration offset magnitude calculator 161 may hold only the time length of the second period and the latest value of the applied state acceleration offset magnitude Ld without holding any of the x-axis linear acceleration signal, the y-axis linear acceleration signal, or the z-axis linear acceleration signal.

Still alternatively, in Step S25, the acceleration offset magnitude calculator 161 may also operate in the following manner. The acceleration offset magnitude calculator 161 calculates, in the second period, the time averages of respective linear acceleration signals over a predetermined time length measured retroactively from the present time and holds the applied state acceleration offset magnitude Ld, of which the respective components are those time averages. The predetermined time length may be 3 seconds, for example. In that case, the acceleration offset magnitude calculator 161 calculates, every time the acceleration average signal A0 is supplied in the second period from the acceleration detection elements 151-153, for example, the time average of the linear acceleration signals over the last 3 seconds, and updates and holds the applied state acceleration offset magnitude Ld.

The control circuit 100 performs these processing steps to end Step S3.

Referring back to FIG. 3, next, the decision processor 130 of the control circuit 100 determines once again whether the composite sensor 1 is in the applied state (in Step S6). A detailed description thereof will be omitted herein because Step S6 is the same as Step S1. If the decision processor 130 has determined that the composite sensor 1 is in the non-applied state (if the answer is NO in Step S6), the control circuit 100 determines that the second period have still continued and performs Step S3 once again. On the otherhand, if the decision processor 130 has determined that the composite sensor 1 is in the applied state (if the answer is YES in Step S6), then the control circuit 100 starts performing Step S2 from the beginning.

### (5) Examples of Offset Correction

### (5.1) Angular Velocity Correction

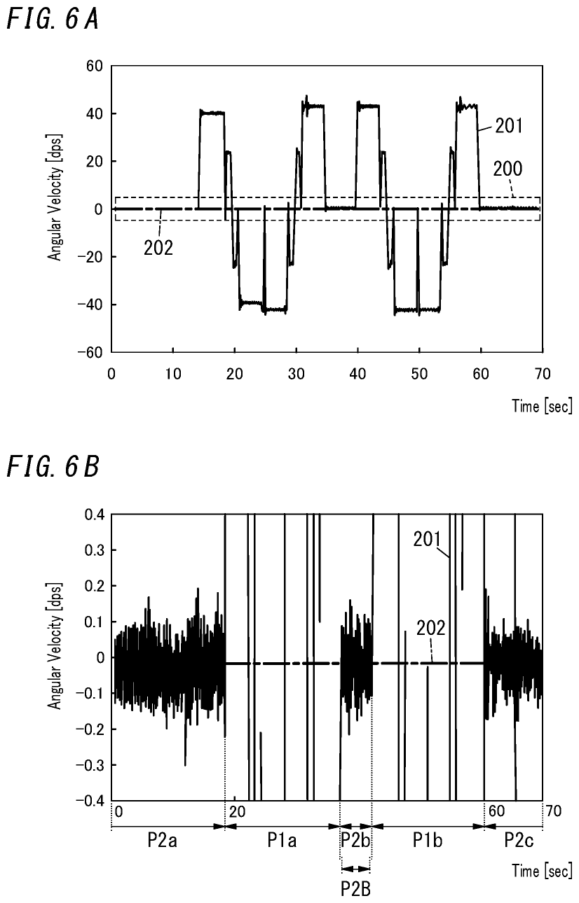

FIG. 6A is a graph showing how an angular velocity signal and an angular velocity offset magnitude change with time. FIG. 6B shows a range 200 shown in FIG. 6A with the axis of ordinates magnified. In FIGS. 6A and 6B, the x-axis angular velocity signal ωx as an angular velocity signal is represented by data 201 and the x-axis angular velocity offset magnitude as an angular velocity offset magnitude is represented by data 202.

As shown in FIG. 6B, in each of second periods P2a, P2b, and P2c, the x-axis angular velocity signal ωx is not equal to zero but its value varies within a range of approximately ±0.2 dps. In the second period, no angular velocity is applied to the composite sensor 1. Thus, the x-axis angular velocity signal ωx in the second period includes noise due to an environmental factor such as heat and an error caused by zero shifting of the x-axis angular velocity signal ωx due to some change involved with the passage of time, for example.

The composite sensor 1 according to the first embodiment calculates its own posture using, instead of the x-axis angular velocity signal ωx, an x-axis angular velocity average signal ω0x that is the time average of the x-axis angular velocity signal ωx. This allows the noise to be averaged and reduced through the time averaging processing. However, the zero shift of the x-axis angular velocity signal ωx cannot be reduced even by the time averaging processing. Thus, the composite sensor 1 according to this first embodiment uses the x-axis angular velocity average signal ω0x as the x-axis angular velocity offset magnitude in each of the second periods P2a, P2b, and P2c. This makes the x-axis corrected angular velocity signal ωax always equal to zero in each of the second periods P2a, P2b, and P2c. Consequently, in the second period P2a, an angular variation around the x-axis, obtained by integrating the x-axis corrected angular velocity signal wax over the second period P2a, becomes equal to zero. That is to say, the angular variation around the x-axis of the composite sensor 1 in the second period P2a becomes equal to zero. Likewise, in each of the second periods P2b, P2c, the angular variation around the x-axis of the composite sensor 1 also becomes equal to zero. That is to say, this reduces the chances of the composite sensor 1 making a computational posture rotation due to accumulation of errors when the composite sensor 1 is actually not rotating.

In addition, the composite sensor 1 regards, in the first period P1a, the time average of the x-axis angular velocity signal ωx over the second period P2a, which is the previous second period just before the first period P1a, as the x-axis angular velocity offset magnitude. Since the first period P1a and the second period P2a are continuous with each other on the time axis, the x-axis angular velocity signal ωx is affected by the noise and the error due to zero shifting of the x-axis angular velocity signal ωx to approximately the same degree in the first period P1a and the second period P2a. This allows the composite sensor 1 to reduce the noise and the error highly accurately by making offset correction to the x-axis angular velocity average signal ω0x for the first period P1a using the time average of the x-axis angular velocity signal ωx over the second period P2a.

In addition, the composite sensor 1 regards, in the first period P1b, the time average of the x-axis angular velocity signal ωx over the second period P2b, which is the previous second period just before the first period P1b, as the x-axis angular velocity offset magnitude. Since the first period P1b and the second period P2b are continuous with each other on the time axis, the x-axis angular velocity signal ωx is affected by the noise and the error due to zero shifting of the x-axis angular velocity signal ωx to approximately the same degree in the first period P1b and the second period P2b. This allows the composite sensor 1 to reduce the noise and the error highly accurately by making offset correction to the x-axis angular velocity average signal ω0x for the first period P1b using the time average of the x-axis angular velocity signal Ox over the second period P2b. Furthermore, to calculate the x-axis angular velocity offset magnitude for the first period P1b, the composite sensor 1 does not use the x-axis angular velocity signal ωx for the second period P2a. This allows, even if the average values of the error are not the same between the second periods P2a and P2b, for example, offset correction to be made in the first period P1b using the error in the second period P2b that would be closest to the error in the first period P1b. That is to say, even if the average value of the error of the x-axis angular velocity signal ωx changes with time, the error may be reduced highly accurately by having the composite sensor 1 make offset correction using the time average of the x-axis angular velocity signal ωx over the last second period.

In the first embodiment described above, in the first period P1b, the time average of the x-axis angular velocity signal ωx over the second period P2b that is the previous second period just before the first period P1b, is regarded as the angular velocity offset magnitude. However, this is only an example and should not be construed as limiting. Alternatively, the time average of the x-axis angular velocity signal ωx over a period P2B which forms part of the second period P2b as the previous second period may also be used as the angular velocity offset magnitude for the first period P1b. The period P2B may be, for example, the rest of the second period P2b other than a period having a duration of 500 ms as measured from the beginning of the second period P2b and a period having a duration of 500 ms as measured retroactively from the end of the second period P2b. In the vicinity of the beginning and end of the second period, even if the decision processor 130 has determined that the composite sensor 1 is in the non-applied state, an angular velocity may be applied to the composite sensor 1 in some cases. Thus, the accuracy of the x-axis angular velocity offset magnitude may be further improved by removing those periods in the vicinity of the beginning and end of the second period from the target period in which the time average of the x-axis angular velocity signal ωx is to be calculated.

Still alternatively, the time average of the x-axis angular velocity signal ωx over a period which forms part of the second period P2b as the previous second period may also be used, for example, as the angular velocity offset magnitude for the first period P1b. The period that forms part of the second period P2b may be, for example, a period having a duration of 3 seconds as measured retroactively from the end of the second period P2b. According to this technique, the angular velocity offset magnitude for the first period P1b is also based on the x-axis angular velocity signal ωx for such a period that forms part of the second period P2b as the previous second period. This allows the error of the x-axis angular velocity signal ωx to be reduced highly accurately in the first period P1b.

Although the foregoing description relates to the x-axis angular velocity signal ωx, the y-axis angular velocity signal ωy and the z-axis angular velocity signal ωz may also be corrected in a similar manner.

### (5.2) Acceleration Correction

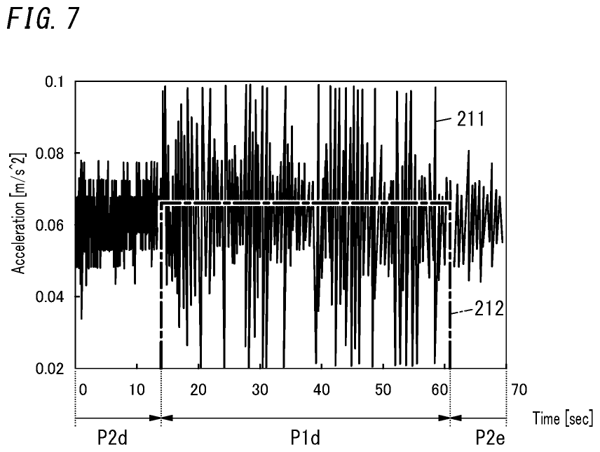

FIG. 7 is a graph showing how a linear acceleration signal and an acceleration offset magnitude change with time. Note that FIG. 7, as well as FIG. 6B, is a partial graph showing only a range where the acceleration values are around zero. Note that in FIG. 7 and the following description, the acceleration signal supplied from the acceleration detection elements 21-23 is replaced with an x-axis linear acceleration signal generated by removing the x component of the gravitational acceleration from the x-axis acceleration signal Ax. In FIG. 7, the x-axis linear acceleration signal is represented by data 211 and the x-axis acceleration offset magnitude is represented by data 212.

As shown in FIG. 7, in the second period P2d, the x-axis linear acceleration signal is not equal to zero, but its value varies within the range of approximately 0.04-0.08 m/s². In the second period, no linear acceleration is applied to the composite sensor 1. Thus, the value of the x-axis linear acceleration signal in the second period includes noise due to an environmental factor such as heat and an error caused by zero shifting of the x-axis acceleration signal Ax due to some change involved with the passage of time, for example. The composite sensor 1 according to the first embodiment calculates its own posture using, instead of the x-axis acceleration signal Ax, an x-axis acceleration average signal A0x that is the time average of the x-axis acceleration signal Ax. This allows the noise to be averaged and reduced through the time averaging processing.

In addition, the composite sensor 1 regards, in the first period P1d, the time average of the x-axis linear acceleration signal over the second period P2d, which is the previous second period just before the first period P1d, as the acceleration offset magnitude. Since the first period P1d and the second period P2d are continuous with each other on the time axis, the x-axis linear acceleration signal is affected by the noise and the error due to zero shifting of the x-axis acceleration signal Ax to approximately the same degree in the first period P1d and the second period P2d. This allows the composite sensor 1 to reduce the error highly accurately by making offset correction to the x-axis acceleration average signal A0x for the first period P1d using the time average of the x-axis linear acceleration signal over the second period P2d.

Note that although not shown in FIG. 7, as in the case of the angular velocity correction, in the first period that follows the second period P2e, the composite sensor 1 regards the time average of the x-axis linear acceleration signal over the second period P2e, which is the previous second period just before the first period, as the acceleration offset magnitude. This allows, even if the average values of the error of the x-axis acceleration signal Ax changes with time due to a temperature variation or variation with time of the composite sensor 1, for example, offset correction to be made in the first period using the error in the second period P2e that would be closest to the error in the first period. That is to say, the error may be reduced highly accurately by making offset correction using the time average of the x-axis linear acceleration signal over the second period just before the first period.

Note that as in the case of offset correction to the angular velocity, the time average of the x-axis linear acceleration signal over a partial period which forms part of the second period P2d as the previous second period just before the first period P1d, for example, may also be used as the acceleration offset magnitude for the first period P1d. The partial period may be, for example, a period which begins at a time later than the beginning of the second period P2d and ends at a time earlier than the end of the second period P2d.

Still alternatively, the time average of the x-axis linear acceleration signal for a partial period which forms part of the second period P2b as the previous second period just before the first period P1b, for example, may also be used as the acceleration offset magnitude for the first period P1b. The partial period that forms part of the second period P2b may be, for example, a period having a duration of 3 seconds as measured retroactively from the end of the second period P2b. According to this technique, the acceleration offset magnitude for the first period P1b is also based on the x-axis linear acceleration signal for such a partial period that forms part of the second period P2b as the previous second period. This allows the error of the x-axis acceleration signal Ax to be reduced highly accurately in the first period P1b.

Although the foregoing description relates to the x-axis acceleration signal Ax, the y-axis acceleration signal Ay and the z-axis acceleration signal Az may also be corrected in a similar manner.

### (6) Advantages

The composite sensor 1 according to the first embodiment makes offset correction to the angular velocity average signal ω0 for the first period based on the angular velocity signal or supplied from the angular velocity detection elements 11-13 in the second period. Since the angular velocity applied to the composite sensor 1 in the second period is zero, the average value of the angular velocity signal or supplied from the angular velocity detection elements 11-13 in the second period is the average of the noise and the error caused by zero shifting of the angular velocity signal or. Thus, the noise and the error may be reduced highly accurately from the angular velocity average signal ω0 by using the time average of the angular velocity signal or supplied from the angular velocity detection elements 11-13 in the second period as the angular velocity offset magnitude. That is to say, the composite sensor 1 according to the first embodiment may improve the accuracy of the corrected angular velocity signal ωa.

In addition, the composite sensor 1 according to the first embodiment does not use the angular velocity signal or for the first period as data for calculating the angular velocity offset magnitude in the first period. This configuration may prevent the angular velocity applied to the composite sensor 1 from being reflected on the angular velocity offset magnitude. This improves the accuracy of the corrected angular velocity signal ωa.

Furthermore, the composite sensor 1 according to the first embodiment makes offset correction to the acceleration average signal A0 for the first period based on the acceleration signal Ar supplied from the acceleration detection elements 21-23 and the gravitational acceleration signal G0 supplied from the acceleration calculator 180 in the second period. Since the linear acceleration applied to the composite sensor 1 in the second period is zero, the time average of the linear acceleration signal over the second period is the time average of the noise and the error between the acceleration signal Ar and the acceleration applied to the composite sensor. Thus, the noise and the error may be reduced highly accurately from the acceleration average signal A0 by using the time average of the linear acceleration signal over the second period as the acceleration offset magnitude. That is to say, the composite sensor 1 according to the first embodiment may improve the accuracy of the corrected acceleration signal Aa.

In addition, the composite sensor 1 according to the first embodiment does not use the acceleration signal Ar for the first period as data for calculating the acceleration offset magnitude for the first period. This configuration may prevent the linear acceleration applied to the composite sensor 1 from being reflected on the acceleration offset magnitude. This improves the accuracy of the corrected acceleration signal Aa.

Furthermore, in the composite sensor 1 according to the first embodiment, the decision processor 130 determines, based on the variation with time of the angular velocity signal or and the variation with time of the acceleration signal Ar, whether the composite sensor 1 is in the applied state where at least one of angular velocity or linear acceleration is applied to the composite sensor 1. This enables determining, by detecting any change in the angular velocity and acceleration applied to the composite sensor 1, whether at least one of acceleration or linear acceleration has been applied to the composite sensor 1.

Furthermore, the composite sensor 1 according to the first embodiment uses the angular velocity average signal ω0 as the angular velocity correction signal ωc in a situation where the composite sensor 1 is in the non-applied state. That is to say, when no angular velocity is applied to the composite sensor 1, the corrected angular velocity signal ωa becomes equal to zero. This may prevent, even if the error between the angular velocity signal or and the angular velocity applied to the composite sensor 1 is not constant, the error from being left in the corrected angular velocity signal ωa to affect the posture prediction of the composite sensor 1 by the signal processor 170 and the quaternion signal Q0. In addition, since the corrected angular velocity signal ωa becomes equal to zero in the first period, the computational magnitude of rotational movement of the composite sensor 1 in the first period should be zero as well. That is to say, this may reduce the error of the posture predicted for the composite sensor 1 due to the accumulation of the error between the angular velocity signal or and the angular velocity applied to the composite sensor 1 in the first period.

### (First Variation)

A composite sensor 1a according to a first variation uses a different method for determining whether the composite sensor 1a is in the applied state, which is a difference from the composite sensor 1 according to the first embodiment.

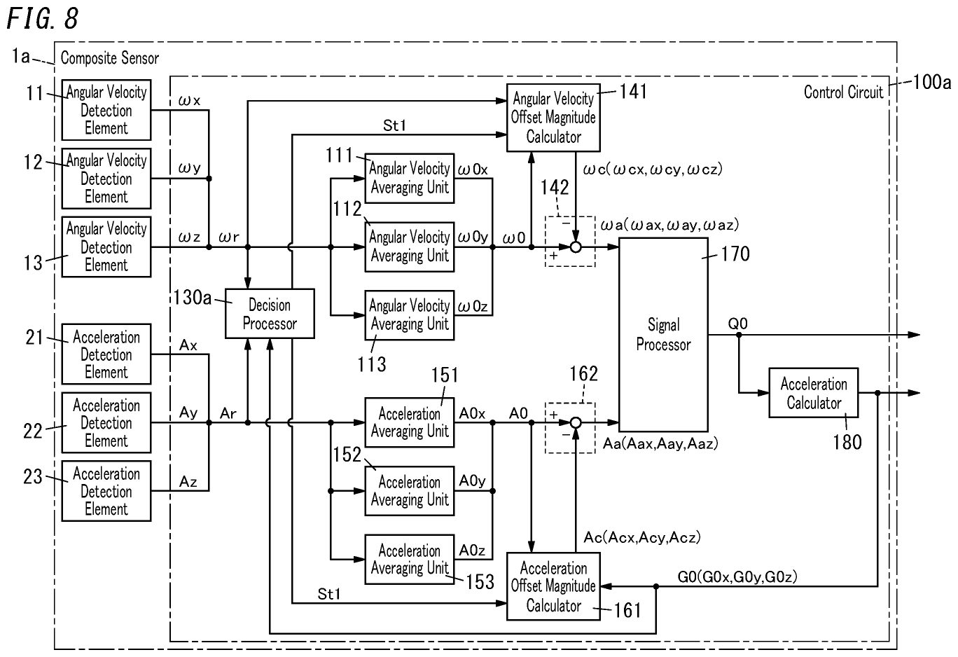

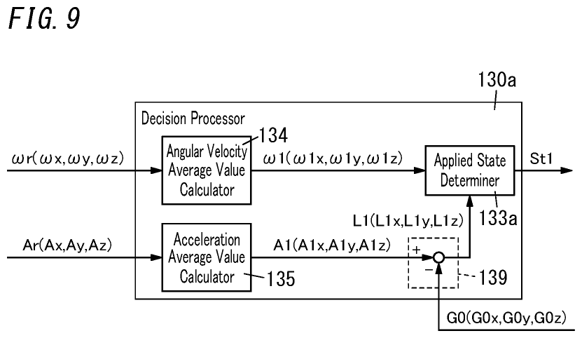

FIG. 8 is a functional block diagram of the composite sensor 1a according to the first variation. The composite sensor 1a includes a control circuit 100a instead of the control circuit 100. The control circuit 100a includes a decision processor 130a instead of the decision processor 130. FIG. 9 is a functional block diagram of the decision processor 130a. As shown in FIG. 9, the decision processor 130a includes an angular velocity average value calculator 134, an acceleration average value calculator 135, a linear acceleration calculator 139, and an applied state determiner 133a.

The angular velocity average value calculator 134 performs time averaging processing on the angular velocity signal or, of which the components are respective outputs of the angular velocity detection elements 11-13, thereby calculating an angular velocity average value (o. The angular velocity average value ω1 includes, as respective components, an x-axis angular velocity average value ω1x, a y-axis angular velocity average value ω1y, and a z-axis angular velocity average value ω1z. The angular velocity average value calculator 134 calculates a time average value of the x-axis angular velocity signal ωx as the x-axis angular velocity average value ω1x. In the same way, the angular velocity average value calculator 134 calculates a time average value of the y-axis angular velocity signal ωy as the y-axis angular velocity average value ω1y. In the same way, the angular velocity average value calculator 134 calculates a time average value of the z-axis angular velocity signal ωz as the z-axis angular velocity average value ω1z.

The acceleration average value calculator 135 performs time averaging processing on the acceleration signal Ar, supplied from the acceleration detection elements 21-23, thereby calculating an acceleration average value A1. The acceleration average value A1 includes, as respective components, an x-axis acceleration average value A1x, a y-axis acceleration average value A1y, and a z-axis acceleration average value A1z. The acceleration average value calculator 135 calculates a time average value of the x-axis acceleration signal Ax as the x-axis acceleration average value A1x. In the same way, the acceleration average value calculator 135 calculates a time average value of the y-axis acceleration signal Ay as the y-axis acceleration average value A1y. In the same way, the acceleration average value calculator 135 calculates a time average value of the z-axis acceleration signal Az as the z-axis acceleration average value A1z.

The linear acceleration calculator 139 calculates a linear acceleration average value L1 by performing the processing of subtracting the gravitational acceleration signal G0 from the acceleration average value A1 supplied from the acceleration average value calculator 135. The linear acceleration average value L1 includes, as respective components, an x-axis linear acceleration average value L1x, a y-axis linear acceleration average value L1y, and a z-axis linear acceleration average value L1z. The linear acceleration calculator 139 calculates the x-axis linear acceleration average value L1x by subtracting the x-axis gravitational acceleration signal G0x from the x-axis acceleration average value Aix. The linear acceleration calculator 139 calculates the y-axis linear acceleration average value L1y by subtracting the y-axis gravitational acceleration signal G0y from the y-axis acceleration average value A1y. The linear acceleration calculator 139 calculates the z-axis linear acceleration average value L1z by subtracting the z-axis gravitational acceleration signal G0z from the z-axis acceleration average value A1z.

The applied state determiner 133a determines, using the angular velocity average value ω1 and the linear acceleration average value L1, whether the composite sensor 1a is in the applied state. The applied state determiner 133a holds, in advance, first through sixth threshold values for the x-axis angular velocity average value ω1x, the y-axis angular velocity average value ω1y, the z-axis angular velocity average value ω1z, the x-axis linear acceleration average value L1x, the y-axis linear acceleration average value L1y, and the z-axis linear acceleration average value L1z, respectively. The applied state determiner 133a compares the respective components of the angular velocity average value ωi with their threshold values. In addition, the applied state determiner 133a also compares the respective components of the linear acceleration average value L1 with their threshold values. When finding any component of the angular velocity average value ω1 greater than its threshold value, the applied state determiner 133a determines that the composite sensor 1a is in the applied state. When finding any component of the linear acceleration average value L1 greater than its threshold value, the applied state determiner 133a determines that the composite sensor 1a is in the applied state. In other words, when finding each component of the angular velocity average value ω1 equal to or less than its threshold value and each component of the linear acceleration average value L1 equal to or less than its threshold value, the applied state determiner 133a determines that the composite sensor 1a is in the non-applied state. That is to say, the applied state determiner 133a determines that the composite sensor 1a is in the applied state if any one of the following Conditions A-F is satisfied:
Condition A: x-axis angular velocity average value ω1x>first threshold value;
Condition B: y-axis angular velocity average value ω1y>second threshold value;
Condition C: z-axis angular velocity average value ω1z>third threshold value;
Condition D: x-axis linear acceleration average value L1x>fourth threshold value;
Condition E: y-axis linear acceleration average value L1y>fifth threshold value; and
Condition F: z-axis linear acceleration average value L1z>sixth threshold value.

When finding none of these Conditions A-F satisfied, the applied state determiner 133a determines that the composite sensor 1a is in the non-applied state. That is to say, the applied state determiner 133a determines that the composite sensor 1a is in the non-applied state if the following six conditions are all satisfied:
First condition: x-axis angular velocity average value ω1x≤first threshold value;
Second condition: y-axis angular velocity average value ω1y≤second threshold value;
Third condition: z-axis angular velocity average value ω1z≤third threshold value;
Fourth condition: x-axis linear acceleration average value L1x≤fourth threshold value;
Fifth condition: y-axis linear acceleration average value L1y≤fifth threshold value; and
Sixth condition: z-axis linear acceleration average value L1z≤sixth threshold value.

Each of the first to third threshold values may be, for example, 0.01 dps. Each of the fourth to sixth threshold values may be, for example, 0.01 m/s². Note that these threshold values are only examples and may be determined arbitrarily depending on the intended use of the composite sensor 1a. Naturally, the threshold values may also be different from each other.

The composite sensor 1a according to this first variation achieves the same advantages as the composite sensor 1 according to the first embodiment. That is to say, the composite sensor 1a according to the first variation may also make offset correction highly accurately to the angular velocity signal or and the acceleration signal Ar.

### Second Embodiment

In a composite sensor 1b according to a second embodiment, the decision processor 130b thereof further determines whether the composite sensor 1b is in an impact applied state where impact is applied to the composite sensor 1b and the angular velocity averaging units 111b-113b perform their processing differently depending on whether the composite sensor 1b is in the impact applied state, which is a difference from the composite sensor 1 according to the first embodiment described above.

### (1) Configuration

### (1.1) Control Circuit

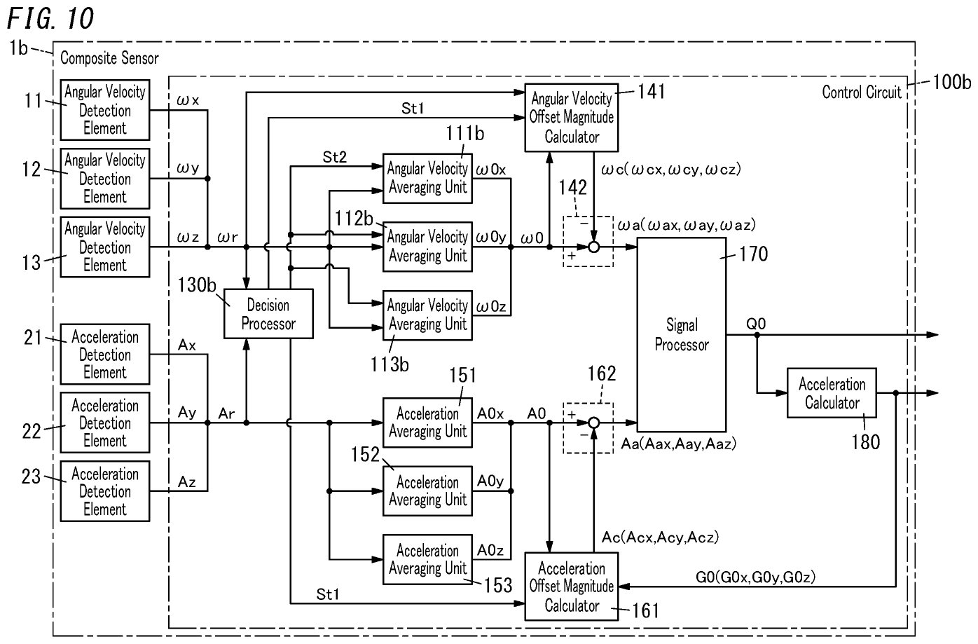

FIG. 10 is a functional block diagram of the composite sensor 1b according to the second embodiment. The composite sensor 1b includes a control circuit 100b instead of the control circuit 100. The control circuit 100b includes angular velocity averaging units 111b, 112b, 113b and the decision processor 130b, which is a difference from the control circuit 100. In the other respects, the composite sensor 1b according to the second embodiment has the same configuration as the composite sensor 1 according to the first embodiment, and therefore, description thereof will be omitted herein.

### (1.2) Decision Processor

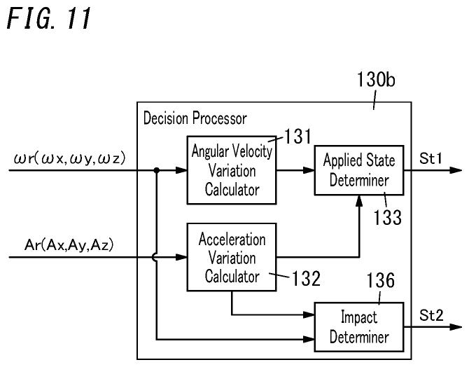

As shown in FIG. 11, the decision processor 130b includes the angular velocity variation calculator 131, the acceleration variation calculator 132, the applied state determiner 133, and an impact determiner 136.

The impact determiner 136 determines whether the composite sensor 1b is in the impact applied state where impact is applied to the composite sensor 1b. As used herein, the “impact applied state” refers to a state where application of impact to the composite sensor 1b causes noise generated by the impact to be applied to the angular velocity signal or. Unless the composite sensor 1b is in the impact applied state, the impact determiner 136 determines, based on the angular velocity signal or and the variation with time of the acceleration signal Ar, whether the composite sensor 1b is in the impact applied state. The impact determiner 136 holds in advance a first angular velocity threshold value, a second angular velocity threshold value, a third angular velocity threshold value, a first acceleration variation threshold value, a second acceleration variation threshold value, and a third acceleration variation threshold value. Then, the impact determiner 136 compares the respective magnitudes of the x-axis angular velocity signal ωx, the y-axis angular velocity signal ωy, and the z-axis angular velocity signal ωz with their threshold values. In addition, the impact determiner 136 also compares the variation with time of the x-axis acceleration signal Ax, the variation with time of the y-axis acceleration signal Ay, and the variation with time of the z-axis acceleration signal Az with their threshold values. When finding any one of the respective magnitudes of the x-axis angular velocity signal ωx, the y-axis angular velocity signal ωy, and the z-axis angular velocity signal ωz greater than its threshold value, the impact determiner 136 determines that the composite sensor 1b is in the impact applied state. In addition, when finding any one of the variation with time of the x-axis acceleration signal Ax, the variation with time of the y-axis acceleration signal Ay, or the variation with time of the z-axis acceleration signal Az greater than its threshold value, the impact determiner 136 determines that the composite sensor 1b is in the impact applied state. That is to say, the impact determiner 136 determines that the composite sensor 1b is in the impact applied state if any one of the following Conditions G-L is satisfied:
Condition G: magnitude of x-axis angular velocity signal ωx>first angular velocity threshold value;
Condition H: magnitude of y-axis angular velocity signal ωy>second angular velocity threshold value;
Condition I: magnitude of z-axis angular velocity signal ωz>third angular velocity threshold value;
Condition J: variation with time of x-axis acceleration signal Ax>first acceleration variation threshold value;
Condition K: variation with time of y-axis acceleration signal Ay>second acceleration variation threshold value; and
Condition L: variation with time of z-axis acceleration signal Az>third acceleration variation threshold value.

In other words, if none of these Conditions G-L are satisfied, the impact determiner 136 determines that the composite sensor 1b is in the non-impact applied state. That is to say, the impact determiner 136 determines that the composite sensor 1b is in the non-impact applied state if the following six conditions are all satisfied in the non-impact applied state:
First condition: magnitude of x-axis angular velocity signal ωx≤first angular velocity threshold value;
Second condition: magnitude of y-axis angular velocity signal ωy≤second angular velocity threshold value;
Third condition: magnitude of z-axis angular velocity signal ωz≤third angular velocity threshold value;
Fourth condition: variation with time of x-axis acceleration signal Ax≤first acceleration variation threshold value;
Fifth condition: variation with time of y-axis acceleration signal Ay≤second acceleration variation threshold value; and
Sixth condition: variation with time of z-axis acceleration signal Az≤third acceleration variation threshold value.

Each of the first, second, and third angular velocity threshold values may be 1 dps, for example. Each of the first, second, and third acceleration variation threshold values may be, for example, 0.0001 m/s²/s. Note that these threshold values are only examples and may be determined arbitrarily depending on the intended use of the composite sensor 1b. Naturally, the threshold values may also be different from each other.

Also, the impact determiner 136 determines, based on the angular velocity signal or when the composite sensor 1b is in the impact applied state, whether the composite sensor 1b has made a transition into the non-impact applied state. The impact determiner 136 holds in advance, a fourth angular velocity threshold value, a fifth angular velocity threshold value, and a sixth angular velocity threshold value. Then, the impact determiner 136 compares the magnitude of the x-axis angular velocity signal ωx with the fourth angular velocity threshold value. In addition, the impact determiner 136 compares the magnitude of the y-axis angular velocity signal ωy with the fifth angular velocity threshold value. Furthermore, the impact determiner 136 compares the magnitude of the z-axis angular velocity signal ωz with the sixth angular velocity threshold value. When finding that the respective magnitudes of the x-axis angular velocity signal ωx, the y-axis angular velocity signal ωy, and the z-axis angular velocity signal ωz all remain less than their threshold values for a predetermined amount of time, the impact determiner 136 determines that the composite sensor 1b have made a transition into the non-impact applied state. In other words, when finding at least one of the respective magnitudes of the x-axis angular velocity signal ωx, the y-axis angular velocity signal ωy, or the z-axis angular velocity signal ωz greater than its threshold value when the composite sensor 1b is in the impact applied state, the impact determiner 136 determines that the composite sensor 1b maintain the impact applied state. Furthermore, when finding the respective magnitudes of the x-axis angular velocity signal ωx, the y-axis angular velocity signal ωy, and the z-axis angular velocity signal ωz all less than their threshold values when the composite sensor 1b is in the impact applied state at a point in time and finding that at least one of the respective magnitudes of the x-axis angular velocity signal ωx, the y-axis angular velocity signal ωy, or the z-axis angular velocity signal ωz has become greater than its threshold value before a predetermined amount of time passes since the point in time, the impact determiner 136 also determines that the composite sensor 1b maintain the impact applied state. Each of the fourth, fifth, and sixth angular velocity threshold values may be 0.01 dps, for example. The predetermined amount of time may be, for example, 100 ms. Note that these threshold values are only examples and may be determined arbitrarily depending on the intended use of the composite sensor 1b. Naturally, the threshold values may also be different from each other.

The impact determiner 136 outputs an impact state signal St2 indicating whether the composite sensor 1b is in the impact applied state.

A period from a point in time when the impact determiner 136 has determined that the composite sensor 1b is in the impact applied state through a point in time when the impact determiner 136 determines that the composite sensor l b have made a transition into the non-impact applied state will be hereinafter referred to as a “third period.” Meanwhile, each continuous period other than the third period will be hereinafter referred to as a “fourth period.” That is to say, the fourth period is a period in which no impact is applied to the composite sensor 1b and no noise is generated by any impact. The third period is a period from a point in time when impact has been applied to the composite sensor 1b through a point in time when noise generated by the impact disappears. The fourth period is a period after the impact has been applied to the composite sensor 1b and the noise generated by the impact has disappeared.

### (1.3) Angular Velocity Averaging Units

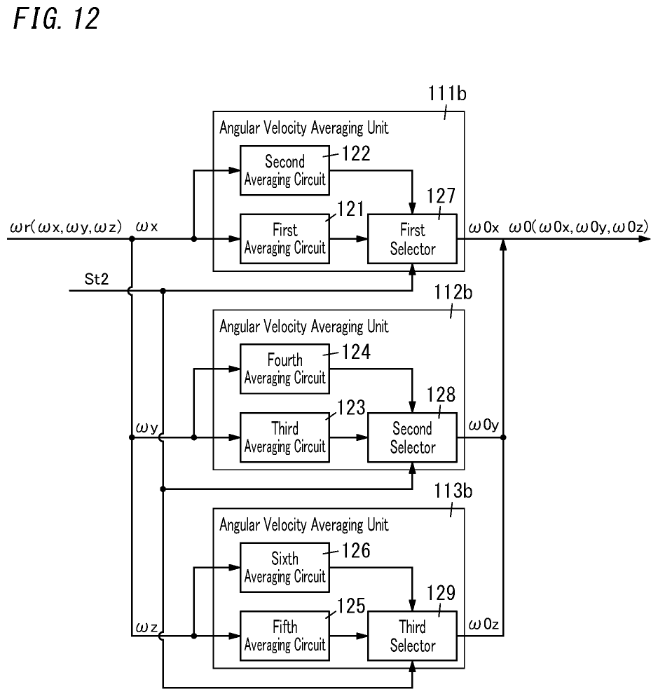

FIG. 12 is a functional block diagram illustrating respective configurations for the angular velocity averaging units 111b-113b.

The angular velocity averaging unit 111b includes a first averaging circuit 121, a second averaging circuit 122, and a first selector 127. The angular velocity averaging unit 112b includes a third averaging circuit 123, a fourth averaging circuit 124, and a second selector 128. The angular velocity averaging unit 113b includes a fifth averaging circuit 125, a sixth averaging circuit 126, and a third selector 129.

The first averaging circuit 121 performs time averaging processing on the x-axis angular velocity signal ωx over a fifth period. The second averaging circuit 122 performs time averaging processing on the x-axis angular velocity signal ωx over a sixth period. The sixth period is longer than the fifth period. The fifth period may have a duration of 100 ms, for example. The sixth period may have a duration of 1 s, for example. That is to say, the first averaging circuit 121 outputs a 100 ms average of the x-axis angular velocity signal ωx every 100 ms. The second averaging circuit 122 outputs a 1 s average of the x-axis angular velocity signal ωx every second. Alternatively, the sixth period may also have a duration of either 500 ms or 2s, for example.

The first selector 127 selects either the output of the first averaging circuit 121 or the output of the second averaging circuit 122 as the x-axis angular velocity average signal ω0x. If the impact state signal St2 indicates that the composite sensor 1b is in the non-impact applied state, then the first selector 127 selects the output of the first averaging circuit 121 as the x-axis angular velocity average signal ω0x. That is to say, if the composite sensor 1b is in the non-impact applied state, the x-axis angular velocity average signal ω0x is the average of the x-axis angular velocity signal ωx over the fifth period. On the other hand, if the impact state signal St2 indicates that the composite sensor 1b is in the impact applied state, then the first selector 127 selects the output of the second averaging circuit 122 as the x-axis angular velocity average signal ω0x. That is to say, if the composite sensor 1b is in the impact applied state, the x-axis angular velocity average signal ω0x is the average of the x-axis angular velocity signal ωx over the sixth period.

The third averaging circuit 123 performs time averaging processing on the y-axis angular velocity signal ωy over a seventh period. The fourth averaging circuit 124 performs time averaging processing on the y-axis angular velocity signal ωy over an eighth period. The eighth period is longer than the seventh period. The seventh period may have a duration of 100 ms, for example. The eighth period may have a duration of 1 s, for example. That is to say, the third averaging circuit 123 outputs a 100 ms average of the y-axis angular velocity signal ωy every 100 ms. The fourth averaging circuit 124 outputs a 1 s average of the y-axis angular velocity signal oy every second.

The second selector 128 selects either the output of the third averaging circuit 123 or the output of the fourth averaging circuit 124 as the y-axis angular velocity average signal ω0y. If the impact state signal St2 indicates that the composite sensor 1b is in the non-impact applied state, then the second selector 128 selects the output of the third averaging circuit 123 as the y-axis angular velocity average signal ω0y. That is to say, if the composite sensor 1b is in the non-impact applied state, the y-axis angular velocity average signal ω0y is the average of the y-axis angular velocity signal ωy over the seventh period. On the other hand, if the impact state signal St2 indicates that the composite sensor 1b is in the impact applied state, then the second selector 128 selects the output of the fourth averaging circuit 124 as the y-axis angular velocity average signal ω0y. That is to say, if the composite sensor 1b is in the impact applied state, the y-axis angular velocity average signal ω0y is the average of the y-axis angular velocity signal ωy over the eighth period.

The fifth averaging circuit 125 performs time averaging processing on the z-axis angular velocity signal ωz over a ninth period. The sixth averaging circuit 126 performs time averaging processing on the z-axis angular velocity signal ωz over a tenth period. The tenth period is longer than the ninth period. The ninth period may have a duration of 100 ms, for example. The tenth period may have a duration of 1 s, for example. That is to say, the fifth averaging circuit 125 outputs a 100 ms average of the z-axis angular velocity signal Oz every 100 ms. The sixth averaging circuit 126 outputs a 1 s average of the z-axis angular velocity signal ωz every second.

The third selector 129 selects either the output of the fifth averaging circuit 125 or the output of the sixth averaging circuit 126 as the z-axis angular velocity average signal ω0z. If the impact state signal St2 indicates that the composite sensor 1b is in the non-impact applied state, then the third selector 129 selects the output of the fifth averaging circuit 125 as the z-axis angular velocity average signal ω0z. That is to say, if the composite sensor 1b is in the non-impact applied state, the z-axis angular velocity average signal ω0z is the average of the z-axis angular velocity signal ωz over the ninth period. On the other hand, if the impact state signal St2 indicates that the composite sensor 1b is in the impact applied state, then the third selector 129 selects the output of the sixth averaging circuit 126 as the z-axis angular velocity average signal ω0z. That is to say, if the composite sensor 1b is in the impact applied state, the z-axis angular velocity average signal ω0z is the average of the z-axis angular velocity signal ωz over the tenth period.

### (2) Angular Velocity Averaging Processing

Next, the angular velocity averaging processing will be described in detail.

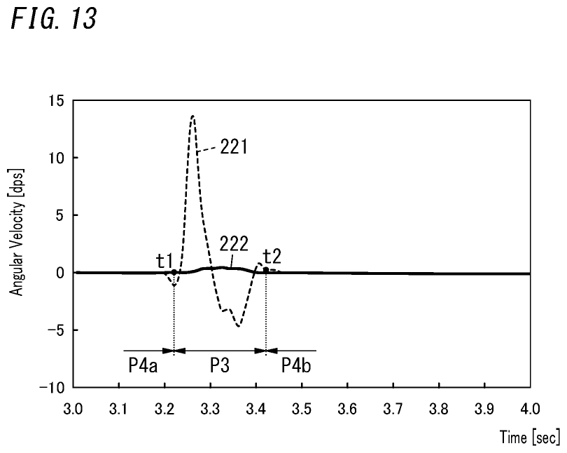

FIG. 13 is a graph showing how the angular velocity signal or and a long-term average signal of the angular velocity change with time. The long-term average signal represents the average of the x-axis angular velocity signal ωx over the sixth period, the average of the y-axis angular velocity signal ωy over the eighth period, or the average of the z-axis angular velocity signal ωz over the tenth period. That is to say, the long-term average signal is the output of any one of the second averaging circuit 122, the fourth averaging circuit 124, or the sixth averaging circuit 126. In FIG. 13, the z-axis angular velocity signal ωz is represented by data 221. In addition, in FIG. 13, the average of the z-axis angular velocity signal ωz over the tenth period is represented by data 222 as the long-term average signal.

When impact is applied to the composite sensor 1b, the angular velocity signal or may come to have significant noise caused by the impact. For example, if the angular velocity detection element 13 for detecting the angular velocity around the z-axis includes a vibrating electrode vibrating in the y-axis direction and a detection electrode for detecting any displacement of the vibrating electrode in the x direction, application of impact to the composite sensor 1b in the x-axis direction generates significant noise in the z-axis angular velocity signal ωz. The noise is generated when the angular velocity detection element 13 detects the displacement of the vibrating electrode caused by the impact in the x direction as displacement due to Coriolis force caused by angular velocity around the z-axis and outputs the z-axis angular velocity signal ωz.

As shown in FIG. 13, the effect of the noise generated by the impact persists for about a few seconds since the application of the impact. The impact determiner 136 detects the impact applied state at a time t1 when the impact is applied to the composite sensor 1b. Also, at a time t2 when the angular velocity signal or indicates that the noise caused by the impact has diminished sufficiently, the impact determiner 136 detects that the composite sensor 1b is in the non-impact applied state. The third period is the period between the times t1 and t2. The period before the time t1 is a fourth period P4a. The period after the time t2 is a fourth period P4b. As shown in FIG. 13, significant noise is generated in the angular velocity signal or in the third period P3.

The noise generated in the angular velocity signal or in the third period P3 may be reduced by extending the averaging period when generating the angular velocity average signal ω0 by calculating the time averages of the respective components of the angular velocity signal ωr. As indicated by data 222 in FIG. 13, using the angular velocity average signal ω0 for the tenth period allows the noise to be averaged, thus reducing the effect of the noise. Nevertheless, constantly extending the period for calculating the angular velocity average signal ω0 makes it difficult to detect the short-term change of the angular velocity signal or and widens the average time lag between the angular velocity signal or and the angular velocity average signal ω0, thus causing a decline in the responsivity of the composite sensor 1b. Thus, the composite sensor 1b extends the period for generating the angular velocity average signal ω0 when the composite sensor 1b is in the impact applied state and shortens the period for generating the angular velocity average signal ω0 otherwise.

### (3) Advantages

The composite sensor 1b according to the second embodiment makes the period for performing the averaging processing on the angular velocity signal or to calculate the angular velocity average signal ω0 longer when the composite sensor 1b is in the impact applied state where impact is applied to the composite sensor 1b than when the composite sensor 1b is in the non-impact applied state. This enables, even if application of impact to the composite sensor 1b causes noise to be generated in the angular velocity signal or supplied from the angular velocity detection elements 11-13, reducing the effect of the noise on the angular velocity average signal ω0. In addition, when the composite sensor 1b is in the non-impact applied state, the composite sensor 1b makes the period for performing the averaging processing on the angular velocity signal or to calculate the angular velocity average signal ω0 shorter than the period when the composite sensor 1b is in the impact applied state. This allows the composite sensor 1b to improve its own responsivity when the composite sensor 1b is in the non-impact applied state.

Furthermore, in the composite sensor 1b according to the second embodiment, even when the composite sensor 1b is in the non-impact applied state, each of the second averaging circuit 122, the fourth averaging circuit 124, and the sixth averaging circuit 126 calculates the angular velocity average signal ω0 for use in the impact applied state. Thus, making each of the angular velocity averaging units 111b-113b change the averaging circuits selected by the first to third selectors 127-129 upon the application of impact to the composite sensor 1b allows the averaging period for calculating the angular velocity average signal ω0 to be changed quickly.

### (Second Variation)

In the composite sensor 1b according to a second variation, each of the angular velocity averaging units 111b-113b includes no selector but includes a single averaging circuit, which is a difference from the composite sensor 1b according to the second embodiment.

The angular velocity averaging unit 111b according to the second variation includes a single averaging circuit. This averaging circuit calculates the time averages of the x-axis angular velocity signal ωx with respect to at least two periods. If the impact state signal St2 indicates that the composite sensor 1b is in the non-impact applied state, the angular velocity averaging unit 111b according to this second variation calculates the time average of the x-axis angular velocity signal ωx for the fifth period.

On the other hand, if the impact state signal St2 indicates that the composite sensor 1b is in the impact applied state, the angular velocity averaging unit 111b according to this second variation calculates the time average of the x-axis angular velocity signal ωx for the sixth period.

The angular velocity averaging unit 111b according to this second variation includes a buffer for holding the x-axis angular velocity signal Ox supplied from the angular velocity detection element 11, for example. In a situation where the impact state signal St2 indicates that the composite sensor 1b is in the impact applied state, when the x-axis angular velocity signal ωx output in the sixth period is held in the buffer, the angular velocity averaging unit 111b according to the second variation calculates and outputs the time average of the x-axis angular velocity signal ox over the sixth period to empty the buffer. On the other hand, in a situation where the impact state signal St2 indicates that the composite sensor 1b is in the non-impact applied state, when the x-axis angular velocity signal ωx output in the fifth period is held in the buffer, the angular velocity averaging unit 111b according to the second variation calculates and outputs the time average of the x-axis angular velocity signal ωx over the fifth period to empty the buffer.

In the same way, if the impact state signal St2 indicates that the composite sensor 1b is in the non-impact applied state, the angular velocity averaging unit 112b according to the second variation calculates the average value of the y-axis angular velocity signal ωy over the seventh period. On the other hand, if the impact state signal St2 indicates that the composite sensor 1b is in the impact applied state, the angular velocity averaging unit 112b according to the second variation calculates the average value of the y-axis angular velocity signal ωy over the eighth period.

If the impact state signal St2 indicates that the composite sensor 1b is in the non-impact applied state, the angular velocity averaging unit 113b according to the second variation calculates the average value of the z-axis angular velocity signal ωz over the ninth period. On the other hand, if the impact state signal St2 indicates that the composite sensor 1b is in the impact applied state, the angular velocity averaging unit 113b according to the second variation calculates the average value of the z-axis angular velocity signal ωy over the tenth period.

The composite sensor 1b according to the second variation makes the target period for performing averaging processing on the angular velocity signal or to calculate the angular velocity average signal ω0 longer when the composite sensor 1b is in the impact applied state than when the composite sensor 1b is in the non-impact applied state. This allows, even if the application of impact to the composite sensor 1b causes noise to be generated in the angular velocity signal or supplied from the angular velocity detection elements 11-13, the effect of the noise on the angular velocity average signal ω0 to be reduced.

Furthermore, in the composite sensor 1b according to the second variation, each of the angular velocity averaging units 111b, 112b, and 113b according to the second variation makes the same averaging circuit calculate the angular velocity average signal ω00, no matter whether the composite sensor 1b is in the impact applied state or not. This allows the angular velocity averaging units 111b-113b according to the second variation to be implemented in a smaller circuit size than the angular velocity averaging units 111b-113b according to the second embodiment.

### Third Embodiment

In a composite sensor 1c according to a third embodiment, an acceleration calculator 180c calculates linear acceleration as acceleration information and an acceleration offset magnitude calculator 161c calculates the applied state acceleration offset magnitude Ld in accordance with the acceleration information, which is a difference from the composite sensor 1 according to the first embodiment.

### (1) Configuration

### (1.1) Control Circuit

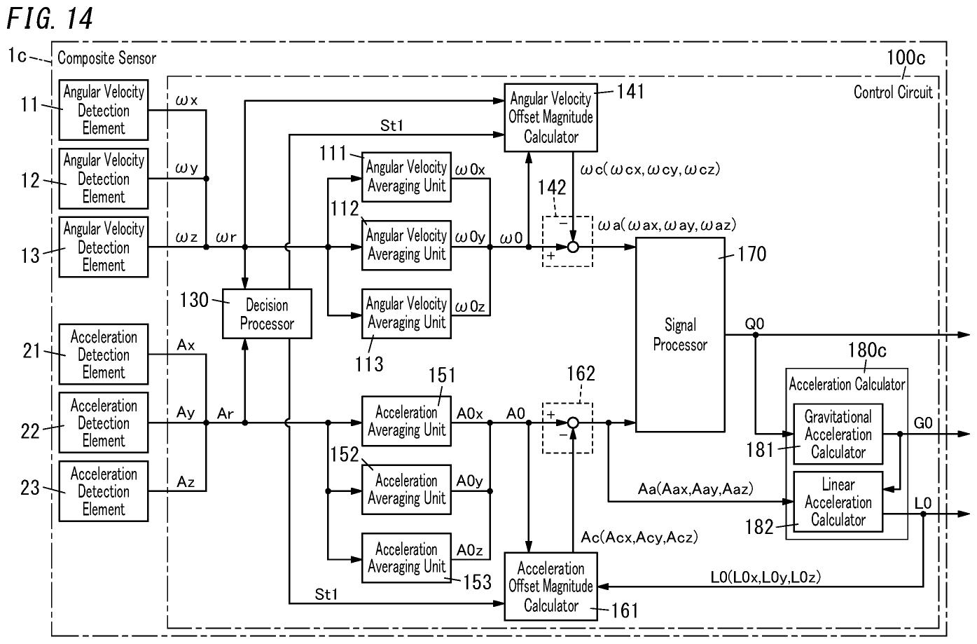

FIG. 14 is a functional block diagram of a composite sensor 1c according to the third embodiment. The composite sensor 1c includes a control circuit 100c instead of the control circuit 100. The control circuit 100c includes the acceleration calculator 180c and the acceleration offset magnitude calculator 161c, which is a difference from the control circuit 100. In the other respects, the composite sensor 1c according to the third embodiment has the same configuration as the composite sensor 1 according to the first embodiment, and therefore, description thereof will be omitted herein.

### (1.2) Acceleration Calculator

The acceleration calculator 180c includes a gravitational acceleration calculator 181 and a linear acceleration calculator 182.

The gravitational acceleration calculator 181 outputs the gravitational acceleration signal G0 in accordance with the quaternion signal Q0 supplied from the signal processor 170. The gravitational acceleration signal G0 includes, as respective components, the x-axis gravitational acceleration signal G0x, the y-axis gravitational acceleration signal G0y, and the z-axis gravitational acceleration signal G0z. The gravitational acceleration calculator 181 calculates x-, y-, and z-components of the gravitational acceleration based on the posture of the composite sensor 1 as represented by the quaternion signal Q0. The gravitational acceleration calculator 181 outputs the gravitational acceleration signal G0 including the x-axis gravitational acceleration signal G0x representing the x component of the gravitational acceleration, the y-axis gravitational acceleration signal G0y representing the y component of the gravitational acceleration, and the z-axis gravitational acceleration signal G0z representing the z component of the gravitational acceleration.

The linear acceleration calculator 182 outputs the linear acceleration signal L0 by subtracting corresponding components of the gravitational acceleration signal G0 supplied from the gravitational acceleration calculator 181 from the respective components of the corrected acceleration signal Aa supplied from the acceleration corrector 162. The linear acceleration signal L0 includes, as respective components, an x-axis linear acceleration signal L0x representing the x component, a y-axis linear acceleration signal L0y representing the y component, and a z-axis linear acceleration signal L0z representing the zs component. The linear acceleration calculator 182 calculates the x-axis linear acceleration signal L0x by subtracting the x-axis gravitational acceleration signal G0x from the x-axis corrected acceleration signal Aax. In the same way, the linear acceleration calculator 182 calculates the y-axis linear acceleration signal L0y by subtracting the y-axis gravitational acceleration signal G0y from the y-axis corrected acceleration signal Aay. In the same way, the linear acceleration calculator 182 calculates the z-axis linear acceleration signal L0z by subtracting the z-axis gravitational acceleration signal G0z from the z-axis corrected acceleration signal Aaz.

### (1.3) Acceleration Offset Magnitude Calculator

The acceleration offset magnitude calculator 161c calculates, based on the applied state signal St1 supplied from the decision processor 130, an acceleration correction signal Ac representing the acceleration offset magnitude to make offset correction to the acceleration average signal A0.

The acceleration offset magnitude calculator 161c acquires the linear acceleration signal L0 from the acceleration calculator 180c.

If the applied state signal St1 indicates that the composite sensor 1c is in the non-applied state, then the acceleration offset magnitude calculator 161c outputs an acceleration correction signal Ac that makes the acceleration offset magnitude zero with respect to all components.

In addition, in the second period in which the applied state signal St1 indicates that the composite sensor 1c is in the non-applied state, the acceleration offset magnitude calculator 161c calculates the applied state acceleration offset magnitude Ld based on the linear acceleration signal L0. The applied state acceleration offset magnitude Ld is the time average of the linear acceleration signal L0 over the second period. That is to say, the applied state acceleration offset magnitude Ld includes, as respective components, the average of the x-axis linear acceleration signal L0x over the second period, the average of the y-axis linear acceleration signal L0y over the second period, and the average of the z-axis linear acceleration signal L0z over the second period.

Note that when the state indicated by the applied state signal St1 changes from the non-applied state into the applied state, the acceleration offset magnitude calculator 161c outputs, as the acceleration correction signal Ac, the applied state acceleration offset magnitude Ld for the previous second period.

In addition, as the state indicated by the applied state signal St1 changes from the applied state into the non-applied state, the acceleration offset magnitude calculator 161c resets the applied state acceleration offset magnitude Ld that has been held to output an acceleration correction signal Ac that makes the acceleration offset magnitude zero with respect to all components. Then, the acceleration offset magnitude calculator 161c calculates the respective time averages of the x-axis linear acceleration signal L0x, the y-axis linear acceleration signal L0y, and the z-axis linear acceleration signal L0z as respective components of the linear acceleration signal L0 for a new second period. The acceleration offset magnitude calculator 161c holds an applied state acceleration offset magnitude Ld, of which the respective components are the time average of the x-axis linear acceleration signal L0x thus calculated, the time average of the y-axis linear acceleration signal L0y thus calculated, and the time average of the z-axis linear acceleration signal L0z thus calculated.

### (2) Advantages

The composite sensor 1c according to the third embodiment also achieves the same advantages as the composite sensor 1 according to the first embodiment. That is to say, the composite sensor 1c according to the third embodiment may also make offset correction highly accurately to the angular velocity average signal ω0 and the acceleration average signal A0.

### (Alternative Variations of Embodiments)

### (First Alternative Variation)

In the first to third embodiments and their variations, the angular velocity offset magnitude calculator 141 calculates, as the applied state angular velocity offset magnitude od, the average value of the angular velocity signal or over the second period and outputs the applied state angular velocity offset magnitude od as the angular velocity correction signal ωc in the first period.

Alternatively, the angular velocity offset magnitude calculator 141 may calculate the applied state angular velocity offset magnitude od using the angular velocity average signal ω0 for the second period, for example.

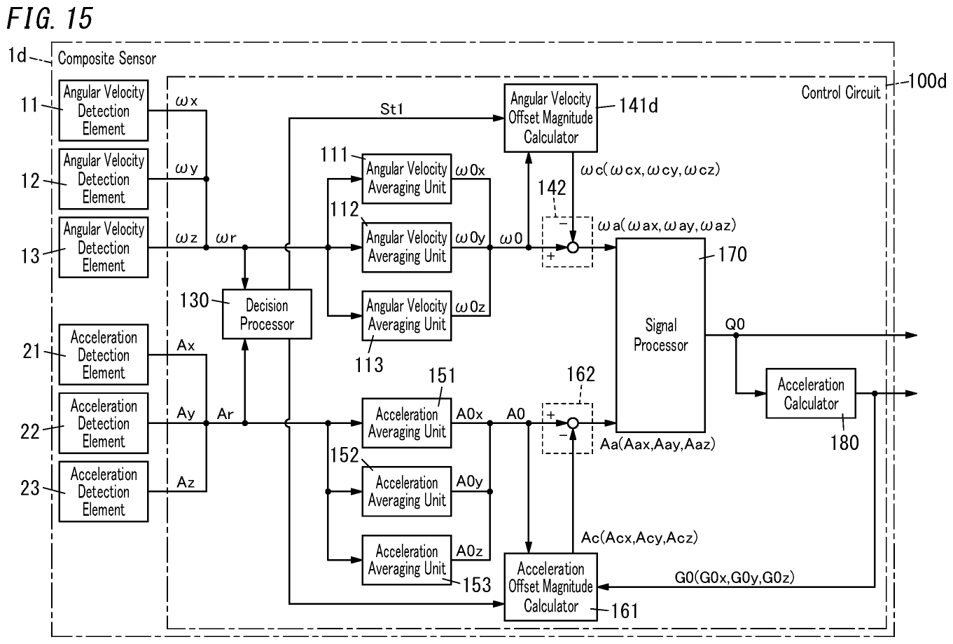

FIG. 15 is a functional block diagram of a composite sensor 1d according to a first alternative variation. A control circuit 100d of this composite sensor 1d includes an angular velocity offset magnitude calculator 141d, which is a difference from the control circuit 100 according to the first embodiment.

In the second period in which the applied state signal St1 indicates that the composite sensor 1d is in the non-applied state, the angular velocity offset magnitude calculator 141d outputs an angular velocity average signal ω0 as the angular velocity correction signal ωc. Then, the angular velocity offset magnitude calculator 141d calculates the time averages of the respective components of the angular velocity average signal ω0 over the second period and holds an applied state angular velocity offset magnitude od, of which the respective components are the time averages thus calculated with respect to the respective components of the angular velocity average signal ω0 over the second period. That is to say, the applied state angular velocity offset magnitude od includes, as respective components, the average of the x-axis angular velocity average signal ω0x over the second period, the average of the y-axis angular velocity average signal ω0y over the second period, and the average of the z-axis angular velocity average signal ω0z over the second period. Then, when the applied state signal St1 indicates that the composite sensor 1d is in the applied state, the angular velocity offset magnitude calculator 141d outputs the applied state angular velocity offset magnitude od as the angular velocity correction signal ωc.

According to this configuration, the applied state angular velocity offset magnitude od as the average value of the angular velocity average signal ω0 over the second period is used as an angular velocity offset magnitude for the first period, thus enabling making offset correction highly accurately to the angular velocity average signal ω0.

### (Second Alternative Variation)

In the first to third embodiments and their variations described above, if the applied state signal St1 indicates that the composite sensor is in the non-applied state, the angular velocity offset magnitude calculator 141 outputs the angular velocity average signal ω0 as the angular velocity correction signal ωc.

Alternatively, when the applied state signal St1 indicates that the composite sensor 1e is in the non-applied state, an angular velocity offset magnitude calculator 141e may, for example, generate the angular velocity correction signal ωc based on the angular velocity signal or and output the angular velocity correction signal ωc.

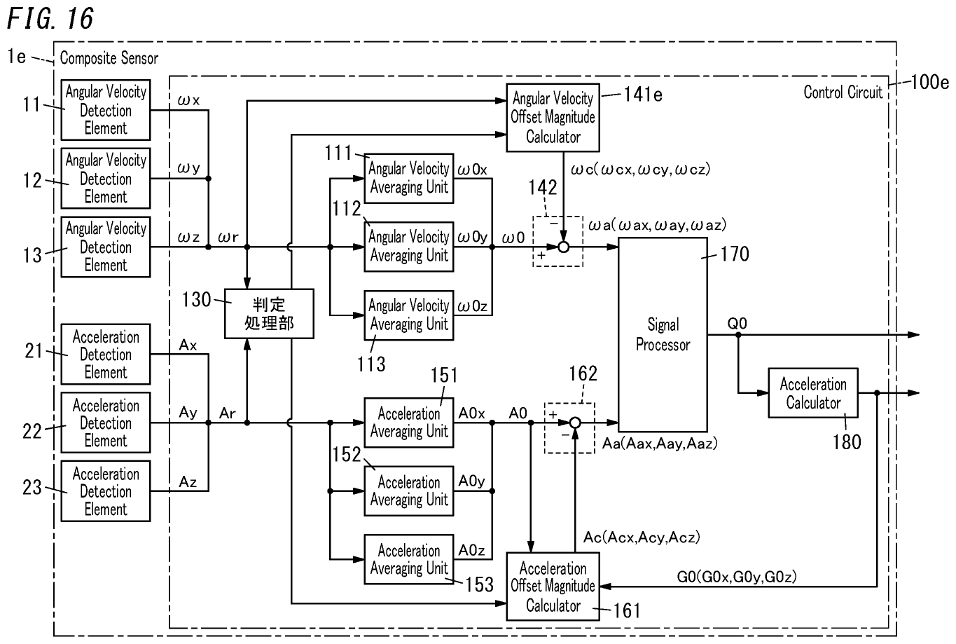

FIG. 16 is a functional block diagram of a composite sensor 1e according to a second alternative variation. A control circuit 100e of this composite sensor 1e includes an angular velocity offset magnitude calculator 141e, which is a difference from the control circuit 100 according to the first embodiment.

In the second period in which the applied state signal St1 indicates that the composite sensor 1e is in the non-applied state, the angular velocity offset magnitude calculator 141e holds an applied state angular velocity offset magnitude od, of which the respective components are the time averages of the respective components of the angular velocity signal Or over the second period. On the other hand, if the applied state signal St1 indicates that the composite sensor 1e is in the applied state, the angular velocity offset magnitude calculator 141e outputs the applied state angular velocity offset magnitude od as the angular velocity correction signal Oc.

Furthermore, if the applied state signal St1 indicates that the composite sensor 1e is in the non-applied state, the angular velocity offset magnitude calculator 141e outputs the angular velocity signal or as the angular velocity correction signal ωc. Alternatively, if the applied state signal St1 indicates that the composite sensor 1e is in the non-applied state, the angular velocity offset magnitude calculator 141e may, for example, output an angular velocity correction signal ωc, of which the respective components are short-term averages of the respective components of the angular velocity signal or. As used herein, the short-term average of each component of the angular velocity signal or may be, for example, the average of each component of the angular velocity signal or per 100 ms. That is to say, the angular velocity correction signal ωc includes, as respective components, the short-term average of the x-axis angular velocity signal ωx, the short-term average of the y-axis angular velocity signal ωy, and the short-term average of the z-axis angular velocity signal ωz.

According to this configuration, the angular velocity offset magnitude for the second period is calculated based on the angular velocity signal or for the second period, thus enabling making offset correction highly accurately to the angular velocity average signal ω0 in the second period.

### (Third Alternative Variation)

In the first embodiment, the angular velocity variation calculator 131 calculates, as an angular velocity parameter, a squared variance of the variation with time of the angular velocity signal or. The acceleration variation calculator 132 calculates, as an acceleration parameter, a squared variance of the variation with time of the acceleration signal Ar. The applied state determiner 133 determines, if the angular velocity parameter is greater than the angular velocity variance threshold value and if the acceleration parameter is greater than the acceleration variance threshold value, that the composite sensor 1 is in the applied state.

Also, in the first variation, the angular velocity average value calculator 134 performs time averaging processing on respective components of the angular velocity signal or, thereby calculating an angular velocity average value ω1, of which the components are the time averages of those components thus calculated. The acceleration average value calculator 135 performs time averaging processing on respective components of the acceleration signal Ar, thereby calculating an acceleration average value A1, of which the components are the time averages of those components thus calculated. The linear acceleration calculator 139 calculates a linear acceleration average value L1 by subtracting the gravitational acceleration signal G0 from the acceleration average value A1. The applied state determiner 133a compares the respective components of the angular velocity average value ω1 and the linear acceleration average value L1 with their corresponding threshold values. When finding any one of the components of the angular velocity average value ω1 greater than its corresponding threshold value, the applied state determiner 133a determines that the composite sensor 1 is in the applied state. Likewise, when finding any one of the components of the linear acceleration average value L1 greater than its corresponding threshold value, the applied state determiner 133a determines that the composite sensor 1 is in the applied state.

However, this is only an exemplary applied state determination method and should not be construed as limiting.

For example, the following applied state determination method may also be adopted. Specifically, the angular velocity variation calculator 131 may calculate, as an angular velocity parameter, the sum of the absolute values of the variations with time in the respective components of the angular velocity signal or. That is to say, the angular velocity variation calculator 131 may divide the variation per unit time by the unit time, add together the absolute values of the quotients thus calculated, and use the sum as the angular velocity parameter with respect to each of the x-axis angular velocity signal ωx, the y-axis angular velocity signal ωy, and the z-axis angular velocity signal ωz. The acceleration variation calculator 132 may calculate, as an acceleration parameter, the sum of the absolute values of the variations with time in the respective components of the acceleration signal Ar. That is to say, the acceleration variation calculator 132 may divide the variation per unit time by the unit time, add together the absolute values of the quotients thus calculated, and use the sum as the acceleration parameter with respect to each of the x-axis acceleration signal Ax, the y-axis acceleration signal Ay, and the z-axis acceleration signal Az. The applied state determiner 133 may determine, when finding both the angular velocity parameter and the acceleration parameter greater than their corresponding threshold values, that the composite sensor 1 is in the applied state. In other words, the applied state determiner 133 may determine, when finding both the angular velocity parameter and the acceleration parameter equal to or less than their corresponding threshold values, that the composite sensor 1 is in the non-applied state. The threshold values for the angular velocity parameter and the acceleration parameter may be, for example, 0.01 dps/s and 0.01 m/s²/s, respectively.

Optionally, the applied state determination method may be a combination of two more of the above-described determination methods.

For example, a decision processor 130a may further include the angular velocity variation calculator 131 and the acceleration variation calculator 132. The applied state determiner 133a may determine, when finding the angular velocity parameter equal to or less than the angular velocity variance threshold value and finding each component of the angular velocity average value ω1 equal to or less than its corresponding threshold value, that no angular velocity be applied to the composite sensor 1a. Also, the applied state determiner 133a may determine, when finding the acceleration parameter equal to or less than the acceleration variance threshold value and finding each component of the linear acceleration average value L1 equal to or less than its corresponding threshold value, that no linear acceleration be applied to the composite sensor 1a. Then, the applied state determiner 133a may determine, if no angular velocity or linear acceleration is being applied to the composite sensor 1a, that the composite sensor 1a is in the non-applied state. In other words, the applied state determiner 133a may determine, when finding the angular velocity parameter greater than the angular velocity variance threshold value and/or finding at least one of the respective components of the angular velocity average value ω1 greater than its corresponding threshold value, that the composite sensor 1a is in the applied state. Likewise, the applied state determiner 133a may also determine, when finding the acceleration parameter greater than the acceleration variance threshold value and/or finding at least one of the respective components of the linear acceleration average value L1 greater than its corresponding threshold value, that the composite sensor 1a is in the applied state.

Optionally, any two or more of the above-described determination methods may be used in combination. Specifically, the decision processor 130a may determine, using at least one of the angular velocity parameter or the angular velocity average value ω1, whether any angular velocity is being applied to the composite sensor 1a and determine, using at least one of the acceleration parameter or the linear acceleration average value L1, whether any linear acceleration is being applied to the composite sensor 1a. The decision processor 130a may determine, when finding the angular velocity parameter greater than the angular velocity variance threshold value and/or finding at least one of the components of the angular velocity average value ω1 greater than its corresponding threshold value, that the composite sensor 1a is in the applied state. Also, the decision processor 130a may determine, when finding the acceleration parameter greater than the acceleration variance threshold value and/or finding at least one of the components of the linear acceleration average value L1 greater than its corresponding threshold value, that the composite sensor 1a is in the applied state. When finding none of these four conditions satisfied, the decision processor 130a determines that the composite sensor 1 is in the non-applied state.

Alternatively, the decision processor 130a may determine, when finding, for example, the difference between at least one component of the angular velocity average value ω1 and a corresponding component of the applied state angular velocity offset magnitude od greater than the threshold value, that angular velocity be being applied to the composite sensor 1a. In other words, the decision processor 130a may determine, when finding the difference between each component of the angular velocity average value ω1 and its corresponding component of the applied state angular velocity offset magnitude od equal to or less than the threshold value, that no angular velocity be being applied to the composite sensor 1a. Likewise, the decision processor 130a may determine, when finding, for example, the difference between at least one component of the linear acceleration average value L1 and a corresponding component of the applied state acceleration offset magnitude Ld greater than the threshold value, that acceleration be being applied to the composite sensor 1a. In other words, the decision processor 130a may determine, when finding the difference between each component of the linear acceleration average value L1 and its corresponding component of the applied state acceleration offset magnitude Ld equal to or less than the threshold value, that no acceleration be being applied to the composite sensor 1a.

Still alternatively, the decision processor 130 may determine, if an angular velocity and linear acceleration are both being applied to the composite sensor 1, for example, that the composite sensor 1 is in the applied state. Otherwise, the decision processor 130 may determine that the composite sensor 1 is in the non-applied state. Yet alternatively, the decision processor 130 may determine, if linear acceleration is being applied to the composite sensor 1, for example, that the composite sensor 1 is in the applied state. Otherwise, the decision processor 130 may determine that the composite sensor 1 is in the non-applied state. Yet alternatively, the decision processor 130 may determine, if angular velocity is being applied to the composite sensor 1, for example, that the composite sensor 1 is in the applied state. Otherwise, the decision processor 130 may determine that the composite sensor 1 is in the non-applied state.

### (Fourth Alternative Variation)

In the second embodiment described above, the impact determiner 136 determines, when finding that the magnitudes of the x-axis angular velocity signal ωx, the y-axis angular velocity signal ωy, and the z-axis angular velocity signal ωz all remain less than their threshold values for a predetermined amount of time in the impact applied state, that a transition have been made to the non-impact applied state.

However, this is only an example and should not be construed as limiting. Alternatively, the impact determiner 136 may also determine, by another criterion, that a transition have been made from the impact applied state to the non-impact applied state.

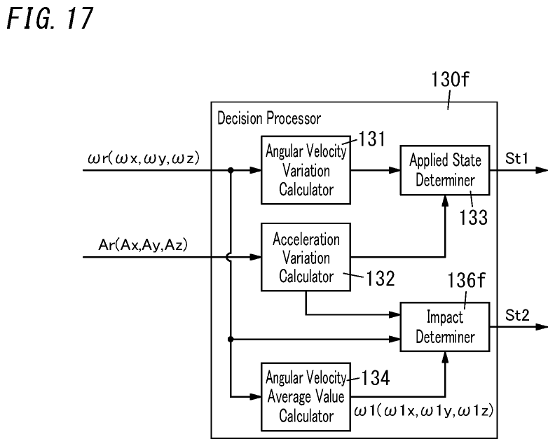

For example, a decision processor 130f may further include the angular velocity average value calculator 134 and an impact determiner 136f as shown in FIG. 17. The impact determiner 136f compares the x-axis angular velocity average value ω1x with a fourth angular velocity threshold value. The impact determiner 136f also compares the y-axis angular velocity average value ω1y with a fifth angular velocity threshold value. The impact determiner 136f further compares the z-axis angular velocity average value ω1z with a sixth angular velocity threshold value. Then, when finding that the x-axis angular velocity average value ω1x, the y-axis angular velocity average value ω1y, and the z-axis angular velocity average value ω1z have all remained less than their corresponding threshold values for a predetermined amount of time, the impact determiner 136f determines that a transition have been made to the non-impact applied state. In other words, the impact determiner 136f determines, when finding at least one of the x-axis angular velocity average value ω1x, the y-axis angular velocity average value ω1y, or the z-axis angular velocity average value ω1z greater than its corresponding threshold value in the impact applied state, that the composite sensor 1 remain in the impact applied state. Furthermore, when finding the x-axis angular velocity average value ω1x, the y-axis angular velocity average value ω1y, and the z-axis angular velocity average value ω1z all less than their corresponding threshold values in the impact applied state at a point in time and finding that at least one of the x-axis angular velocity average value ω1x, the y-axis angular velocity average value ω1y, or the z-axis angular velocity average value ω1z has become greater than its corresponding threshold value before a predetermined amount of time passes since the point in time, the impact determiner 136f also determines that the composite sensor 1 remain in the impact applied state. Note that the fourth, fifth, and sixth angular velocity threshold values and the predetermined amount of time may be different from the fourth, fifth, and sixth angular velocity threshold values and the predetermined amount of time that have been described for the second embodiment.

Alternatively, the impact determiner 136f may determine, when finding the x-axis angular velocity average value ω1x, the y-axis angular velocity average value ω1y, and the z-axis angular velocity average value ω1z all less than their corresponding threshold values, for example, that a transition have been made to the non-impact applied state. In other words, when finding at least one of the x-axis angular velocity average value ω1x, the y-axis angular velocity average value ω1y, or the z-axis angular velocity average value ω1z greater than its corresponding threshold value, the impact determiner 136f determines that the composite sensor 1 remain in the impact applied state. Note that the fourth, fifth, and sixth angular velocity threshold values may be different from the fourth, fifth, and sixth angular velocity threshold values that have been described for the second embodiment.

### (Fifth Alternative Variation)

In the third embodiment, the linear acceleration calculator 182 outputs the linear acceleration signal L0 based on the acceleration average signal A0 supplied from the acceleration averaging units 151-153 and the gravitational acceleration signal G0 supplied from the gravitational acceleration calculator 181. However, the linear acceleration calculator 182 does not have to calculate the linear acceleration signal L0 in this manner. Alternatively, the linear acceleration calculator 182 may output the linear acceleration signal L0 based on the quaternion signal Q0, for example.

### (Sixth Alternative Variation)

In the first to third embodiments and their variations described above, the composite sensor 1 includes the angular velocity detection elements 11-13 and the acceleration detection elements 21-23.

Alternatively, the composite sensor 1 may include a hexaxial detection element, for example. The hexaxial detection element has all the functions of the angular velocity detection element 11, the angular velocity detection element 12, the angular velocity detection element 13, the acceleration detection element 21, the acceleration detection element 22, and the acceleration detection element 23. Still alternatively, the composite sensor 1 may include a triaxial angular velocity detection element and a triaxial acceleration detection element. The triaxial angular velocity detection element has all the functions of the angular velocity detection element 11, the angular velocity detection element 12, and the angular velocity detection element 13. The triaxial acceleration detection element has all the functions of the acceleration detection element 21, the acceleration detection element 22, and the acceleration detection element 23. Note that this is only an exemplary combination of detection elements and any other appropriate combination of detection elements may also be used as long as the combination of detection elements allows angular velocity and acceleration to be detected around each of the three detection axes that are perpendicular to each other.

Optionally, the composite sensor 1 may include a plurality of angular velocity detection elements each having the ability to detect angular velocity around the same detection axis. This allows the angular velocity signals generated by a plurality of angular velocity detection elements for detecting angular velocity around the same detection axis to be averaged so that the average angular velocity is used as the angular velocity around the detection axis. For example, if the composite sensor 1 includes a plurality of angular velocity detection elements, each of which outputs an angular velocity signal representing the angular velocity around the x-axis, then the x-axis angular velocity signal ω0x may be the average value of the plurality of angular velocity signals, each representing the angular velocity around the x-axis. Likewise, the composite sensor 1 may include a plurality of acceleration detection elements each having the ability to detect acceleration along the same detection axis. This allows the acceleration signals generated by a plurality of acceleration detection elements for detecting acceleration along the same detection axis to be averaged so that the average acceleration is used as the acceleration along the detection axis. For example, if the composite sensor 1 includes a plurality of acceleration detection elements, each of which outputs an acceleration signal representing the acceleration along the x-axis, then the x-axis acceleration signal Ax may be the average value of the plurality of acceleration signals, each representing the acceleration along the x-axis.

### (Recapitulation)

A composite sensor (1-1e) according to a first aspect includes a first angular velocity detection element (11), a second angular velocity detection element (12), a third angular velocity detection element (13), a first acceleration detection element (21), a second acceleration detection element (22), a third acceleration detection element (23), and a control circuit (100-100e). The first angular velocity detection element (11) detects angular velocity around a first detection axis to output a first angular velocity signal (ωx). The second angular velocity detection element (12) detects angular velocity around a second detection axis to output a second angular velocity signal (oy). The third angular velocity detection element (13) detects angular velocity around a third detection axis to output a third angular velocity signal (ωz). The first acceleration detection element (21) detects acceleration in a direction aligned with the first detection axis to output a first acceleration signal (Ax). The second acceleration detection element (22) detects acceleration in a direction aligned with the second detection axis to output a second acceleration signal (Ay). The third acceleration detection element (23) detects acceleration in a direction aligned with the third detection axis to output a third acceleration signal (Az). The control circuit (100-100e) processes the first angular velocity signal (ωx), the second angular velocity signal (ωy), the third angular velocity signal (ωz), the first acceleration signal (Ax), the second acceleration signal (Ay), and the third acceleration signal (Az). The first detection axis, the second detection axis, and the third detection axis are perpendicular to each other. The control circuit (100-100e) includes a first acceleration averaging unit (151), a second acceleration averaging unit (152), a third acceleration averaging unit (153), a decision processor (130; 130a; 130b; 130f), an acceleration offset magnitude calculator (161; 161c), an acceleration corrector (162), a signal processor (170), and an acceleration calculator (180; 180c). The first acceleration averaging unit (151) calculates a time average of the first acceleration signal (Ax) to generate a first acceleration average signal (A0x). The second acceleration averaging unit (152) calculates a time average of the second acceleration signal (Ay) to generate a second acceleration average signal (A0y). The third acceleration averaging unit (153) calculates a time average of the third acceleration signal (Az) to generate a third acceleration average signal (A0z). The decision processor (130; 130a; 130b; 130f) determines whether the composite sensor (1-1e) is in an applied state in which at least one of angular velocity or acceleration is applied to the composite sensor (1-1e). The acceleration offset magnitude calculator (161; 161c) calculates magnitude of offset correction with respect to the first acceleration average signal (A0x) to output a first acceleration correction signal (Acx). The acceleration offset magnitude calculator (161; 161c) further calculates magnitude of offset correction with respect to the second acceleration average signal (A0y) to output a second acceleration correction signal (Acy). The acceleration offset magnitude calculator (161; 161c) further calculates magnitude of offset correction with respect to the third acceleration average signal (A0z) to output a third acceleration correction signal (Acz). The acceleration corrector (162) applies the first acceleration correction signal (Acx) to the first acceleration average signal (A0x) to output a first corrected acceleration signal (Aax). The acceleration corrector (162) also applies the second acceleration correction signal (Acy) to the second acceleration average signal (A0y) to output a second corrected acceleration signal (Aay). The acceleration corrector (162) further applies the third acceleration correction signal (Acz) to the third acceleration average signal (A0z) to output a third corrected acceleration signal (Aaz). The signal processor (170) outputs a quaternion signal (Q0) based on angular velocity information, the first corrected acceleration signal (Aax), the second corrected acceleration signal (Aay), and the third corrected acceleration signal (Aaz). The angular velocity information is based on the first angular velocity signal (ωx), the second angular velocity signal (ωy), and the third angular velocity signal (ωz). The acceleration calculator (180; 180c) calculates, based on the quaternion signal (Q0), at least one of gravitational acceleration (G0) or linear acceleration (L0) as acceleration information. The acceleration offset magnitude calculator (161; 161c) calculates, in accordance with the acceleration information in a second period, the first acceleration correction signal (Acx), the second acceleration correction signal (Acy), and the third acceleration correction signal (Acz) for a first period. The second period is a period in which the decision processor (130; 130a; 130b; 130f) has determined that the composite sensor (1-1e) is not in the applied state. The first period is a period in which the decision processor (130; 130a; 130b; 130f) has determined that the composite sensor (1-1e) is in the applied state.

The composite sensor (1-1e) according to the first aspect corrects the first acceleration average signal (A0x), the second acceleration average signal (A0y), and the third acceleration average signal (A0z) in accordance with the acceleration information in a second period in which neither acceleration nor angular velocity is applied to the composite sensor (1-1e). This improves the accuracy of the first acceleration correction signal (Acx), the second acceleration correction signal (Acy), and the third acceleration correction signal (Acz).

In a composite sensor (1; 1a; 1b; 1d; 1e) according to a second aspect, which may be implemented in conjunction with the first aspect, the acceleration information is the gravitational acceleration (G0). The acceleration calculator (180) calculates, as the gravitational acceleration (G0), a first gravitational acceleration signal (G0x) as a component aligned with the first detection axis, a second gravitational acceleration signal (G0y) as a component aligned with the second detection axis, and a third gravitational acceleration signal (G0z) as a component aligned with the third detection axis. The acceleration offset magnitude calculator (161) calculates, based on a first linear acceleration signal (L0x) for the second period, the first acceleration correction signal (Acx) for the first period. The first linear acceleration signal (L0x) represents a difference between the first acceleration average signal (A0x) and the first gravitational acceleration signal (G0x). The acceleration offset magnitude calculator (161) also calculates, based on a second linear acceleration signal (L0y) for the second period, the second acceleration correction signal (Acy) for the first period. The second linear acceleration signal (L0y) represents a difference between the second acceleration average signal (A0y) and the second gravitational acceleration signal (G0y). The acceleration offset magnitude calculator (161) further calculates, based on a third linear acceleration signal (L0z) for the second period, the third acceleration correction signal (Acz) for the first period. The third linear acceleration signal (L0z) represents a difference between the third acceleration average signal (A0z) and the third gravitational acceleration signal (G0z).

The composite sensor (1; 1a; 1b; 1d; 1e) according to the second aspect corrects the first acceleration average signal (A0x), the second acceleration average signal (A0y), and the third acceleration average signal (A0z) based on the linear acceleration (L0) for the second period in which neither acceleration nor angular velocity is applied to the composite sensor (1; 1a; 1b; 1d; 1e). This improves the accuracy of the first acceleration correction signal (Acx), the second acceleration correction signal (Acy), and the third acceleration correction signal (Acz).

In a composite sensor (1c) according to a third aspect, which may be implemented in conjunction with the first aspect, the acceleration information is the linear acceleration (L0). The acceleration calculator (180c) calculates, as the linear acceleration (L0), a first linear acceleration signal (L0x) as a component aligned with the first detection axis, a second linear acceleration signal (L0y) as a component aligned with the second detection axis, and a third linear acceleration signal (L0z) as a component aligned with the third detection axis. The acceleration offset magnitude calculator (161c) calculates, based on the first linear acceleration signal (L0x) for the second period, the first acceleration correction signal (Acx) for the first period. The acceleration offset magnitude calculator (161c) also calculates, based on the second linear acceleration signal (L0y) for the second period, the second acceleration correction signal (Acy) for the first period. The acceleration offset magnitude calculator (161c) further calculates, based on the third linear acceleration signal (L0z) for the second period, the third acceleration correction signal (Acz) for the first period.

The composite sensor (1c) according to the third aspect corrects, based on the linear acceleration (L0) for the second period in which neither acceleration nor angular velocity is applied to the composite sensor (1c), the first acceleration average signal (A0x), the second acceleration average signal (A0y), and the third acceleration average signal (A0z). This improves the accuracy of the first acceleration correction signal (Acx), the second acceleration correction signal (Acy), and the third acceleration correction signal (Acz).

In a composite sensor (1-1e) according to a fourth aspect, which may be implemented in conjunction with any one of the first to third aspects, the control circuit (100-100e) further includes a first angular velocity averaging unit (111; 111b), a second angular velocity averaging unit (112; 112b), a third angular velocity averaging unit (113; 113b), an angular velocity offset magnitude calculator (141; 141d; 141e), and an angular velocity corrector (142). The first angular velocity averaging unit (111; 1l1b) calculates a time average of the first angular velocity signal (ωx) to generate a first angular velocity average signal (ω0x). The second angular velocity averaging unit (112; 112b) calculates a time average of the second angular velocity signal (ωy) to generate a second angular velocity average signal (ω0y). The third angular velocity averaging unit (113; 113b) calculates a time average of the third angular velocity signal (ωz) to generate a third angular velocity average signal (ω0z). The angular velocity offset magnitude calculator (141; 141d; 141e) calculates magnitude of offset correction with respect to the first angular velocity average signal (ω0x) to output a first angular velocity correction signal (ωcx). The angular velocity offset magnitude calculator (141; 141d; 141e) also calculates magnitude of offset correction with respect to the second angular velocity average signal (ω0y) to output a second angular velocity correction signal (ωcy). The angular velocity offset magnitude calculator (141; 141d; 141e) further calculates magnitude of offset correction with respect to the third angular velocity average signal (ω0z) to output a third angular velocity correction signal (ωcz). The angular velocity corrector (142) applies the first angular velocity correction signal (ωcx) to the first angular velocity average signal (ω0x) to output a first corrected angular velocity signal (ωax). The angular velocity corrector (142) also applies the second angular velocity correction signal (ωcy) to the second angular velocity average signal (ω0y) to output a second corrected angular velocity signal (ωay). The angular velocity corrector (142) further applies the third angular velocity correction signal (ωcz) to the third angular velocity average signal (ω0z) to output a third corrected angular velocity signal (ωaz). The signal processor (170) uses, as the angular velocity information, the first corrected angular velocity signal (ωax), the second corrected angular velocity signal (ωay), and the third corrected angular velocity signal (ωaz). The angular velocity offset magnitude calculator (141; 141d; 141e) calculates, based on the first angular velocity signal (ωx) for the second period, the first angular velocity correction signal (ωcx) for the first period. The angular velocity offset magnitude calculator (141; 141d; 141e) also calculates, based on the second angular velocity signal (ωy) for the second period, the second angular velocity correction signal (ωcy) for the first period. The angular velocity offset magnitude calculator (141; 141d; 141e) further calculates, based on the third angular velocity signal (ωz) for the second period, the third angular velocity correction signal (ωcz) for the first period.

The composite sensor (1-1e) according to the fourth aspect corrects, based on the angular velocity information for the second period in which neither acceleration nor angular velocity is applied to the composite sensor (1-1e), the first angular velocity average signal (ωx), the second angular velocity average signal (ωy), and the third angular velocity average signal (ω0z). This improves the accuracy of the first angular velocity correction signal (ωcx), the second angular velocity correction signal (ωcy), and the third angular velocity correction signal (ωcz).

In a composite sensor (1; 1b-1e) according to a fifth aspect, which may be implemented in conjunction with any one of the first to fourth aspects, the decision processor (130; 130b; 130f) includes an angular velocity variation calculator (131), an acceleration variation calculator (132), and an applied state determiner (133). The angular velocity variation calculator (131) calculates an angular velocity variation squared variance value representing a variance of respective time variations of the first angular velocity signal (ωx), the second angular velocity signal (ωy), and the third angular velocity signal (ωz). The acceleration variation calculator (132) calculates an acceleration variation squared variance value representing a variance of respective time variations of the first acceleration signal (Ax), the second acceleration signal (Ay), and the third acceleration signal (Az). The applied state determiner (133) determines, based on the angular velocity variation squared variance value and the acceleration variation squared variance value, whether the composite sensor (1; 1b-1e) is in the applied state. The applied state determiner (133) determines that the composite sensor (1; 1b-1e) is not in the applied state when finding the angular velocity variation squared variance value equal to or less than an angular velocity variance threshold value and finding the acceleration variation squared variance value equal to or less than an acceleration variance threshold value and otherwise determines that the composite sensor (1; 1b-1e) is in the applied state.

The composite sensor (1; 1b-1e) according to the fifth aspect may accurately determine, based on the respective time variations of the first to third angular velocity signals (ωx, ωy, ωz) and the respective time variations of the first to third acceleration signals (Ax, Ay, Az), whether the composite sensor (1; 1b-1e) is in the applied state or not.

In a composite sensor (1a) according to a sixth aspect, which may be implemented in conjunction with the second aspect, the decision processor (130a) includes an angular velocity average value calculator (134), an acceleration average value calculator (135), a linear acceleration calculator (139), and an applied state determiner (133a). The angular velocity average value calculator (134) calculates a first angular velocity average value (ω1x) as a time average of the first angular velocity signal (ωx). The angular velocity average value calculator (134) also calculates a second angular velocity average value (ω1y) as a time average of the second angular velocity signal (ωy). The angular velocity average value calculator (134) further calculates a third angular velocity average value (ω1z) as a time average of the third angular velocity signal (ωz). The acceleration average value calculator (135) calculates a first acceleration average value (A1x) as a time average of the first acceleration signal (Ax). The acceleration average value calculator (135) also calculates a second acceleration average value (A1y) as a time average of the second acceleration signal (Ay). The acceleration average value calculator (135) further calculates a third acceleration average value (A1z) as a time average of the third acceleration signal (Az). The linear acceleration calculator (139) calculates a first linear acceleration average value (L1x), a second linear acceleration average value (L1y), and a third linear acceleration average value (L1z) based on the gravitational acceleration (G0), the first acceleration average value (A1x), the second acceleration average value (A1y), and the third acceleration average value (A1z). The applied state determiner (133a) determines, based on the first angular velocity average value (ω1x), the second angular velocity average value (ω1y), the third angular velocity average value (ω1z), the first linear acceleration average value (L1x), the second linear acceleration average value (L1y), and the third linear acceleration average value (L1z), whether the composite sensor (1a) is in the applied state. The linear acceleration calculator (139) calculates a difference between the first acceleration average value (A1x) and the first gravitational acceleration signal (G0x) as the first linear acceleration average value (L1x). The linear acceleration calculator (139) also calculates a difference between the second acceleration average value (A1y) and the second gravitational acceleration signal (G0y) as the second linear acceleration average value (L1y). The linear acceleration calculator (139) further calculates a difference between the third acceleration average value (A1z) and the third gravitational acceleration signal (G0z) as the third linear acceleration average value (L1z). The applied state determiner (133a) determines that the composite sensor (1a) is not in the applied state when finding: the first angular velocity average value (ω1x) equal to or less than a first threshold value, the second angular velocity average value (ω1y) equal to or less than a second threshold value, the third angular velocity average value (ω1z) equal to or less than a third threshold value, the first linear acceleration average value (L1x) equal to or less than a fourth threshold value, the second linear acceleration average value (L1y) equal to or less than a fifth threshold value, and the third linear acceleration average value (L1z) equal to or less than a sixth threshold value, and otherwise determines that the composite sensor (1a) is in the applied state.

The composite sensor (1a) according to the sixth aspect may accurately determine, based on respective time averages of the first to third angular velocity signals (ωx, ωy, ωz) and respective time averages of the first to third acceleration signals (Ax, Ay, Az), whether the composite sensor (1a) is in the applied state.

In a composite sensor (1a) according to a seventh aspect, which may be implemented in conjunction with the second aspect, the decision processor (130a) includes an angular velocity variation calculator (131), an acceleration variation calculator (132), an angular velocity average value calculator (134), an acceleration average value calculator (135), a linear acceleration calculator (139), and an applied state determiner (133a). The angular velocity variation calculator (131) calculates an angular velocity variation squared variance value representing a variance of respective time variations of the first angular velocity signal (ωx), the second angular velocity signal (ωy), and the third angular velocity signal (ωz). The acceleration variation calculator (132) calculates an acceleration variation squared variance value representing a variance of respective time variations of the first acceleration signal (Ax), the second acceleration signal (Ay), and the third acceleration signal (Az). The angular velocity average value calculator (134) calculates a first angular velocity average value (lx) as a time average of the first angular velocity signal (ωx). The angular velocity average value calculator (134) also calculates a second angular velocity average value (ω1y) as a time average of the second angular velocity signal (ωy). The angular velocity average value calculator (134) further calculates a third angular velocity average value (ω1z) as a time average of the third angular velocity signal (ωz). The acceleration average value calculator (135) calculates a first acceleration average value (A1x) as a time average of the first acceleration signal (Ax). The acceleration average value calculator (135) also calculates a second acceleration average value (A1y) as a time average of the second acceleration signal (Ay). The acceleration average value calculator (135) further calculates a third acceleration average value (A1z) as a time average of the third acceleration signal (Az). The linear acceleration calculator (139) calculates a first linear acceleration average value (L1x), a second linear acceleration average value (L1y), and a third linear acceleration average value (L1z) based on the gravitational acceleration (G0), the first acceleration average value (A1x), the second acceleration average value (A1y), and the third acceleration average value (A1z). The applied state determiner (133a) determines whether the composite sensor (1a) is in the applied state. The linear acceleration calculator (139) calculates a difference between the first acceleration average value (A1x) and the first gravitational acceleration signal (G0x) as the first linear acceleration average value (L1x). The linear acceleration calculator (139) also calculates a difference between the second acceleration average value (A1y) and the second gravitational acceleration signal (G0y) as the second linear acceleration average value (L1y). The linear acceleration calculator (139) further calculates a difference between the third acceleration average value (A1z) and the third gravitational acceleration signal (G0z) as the third linear acceleration average value (L1z). The applied state determiner (133a) determines that the composite sensor (1a) is not in the applied state when finding: the angular velocity variation squared variance value equal to or less than an angular velocity variance threshold value; the acceleration variation squared variance value equal to or less than an acceleration variance threshold value; the first angular velocity average value (ω1x) equal to or less than a first threshold value, the second angular velocity average value (ω1y) equal to or less than a second threshold value, the third angular velocity average value (ω1z) equal to or less than a third threshold value, the first linear acceleration average value (L1x) equal to or less than a fourth threshold value, the second linear acceleration average value (L1y) equal to or less than a fifth threshold value, and the third linear acceleration average value (L1z) equal to or less than a sixth threshold value, and otherwise determines that the composite sensor (1a) is in the applied state.

The composite sensor (1a) according to the seventh aspect may accurately determine, based on respective time variations of the first to third angular velocity signals (ωx, ωy, ωz), respective time variations of the first to third acceleration signals (Ax, Ay, Az), respective time averages of the first to third angular velocity signals (ωx, ωy, ωz), and respective time averages of the first to third acceleration signals (Ax, Ay, Az), whether the composite sensor (1a) is in the applied state.

In a composite sensor (1b) according to an eighth aspect, which may be implemented in conjunction with the fourth aspect, the decision processor (130; 130f) further determines whether the composite sensor (1b) is in an impact applied state where impact is applied to the composite sensor (1b). The first angular velocity averaging unit (111b) outputs, in a fourth period in which the decision processor (130b; 130f) determines that the composite sensor (1b) is not in the impact applied state, an average of the first angular velocity signal (ωx) over a fifth period as the first angular velocity average signal (ω0x). The first angular velocity averaging unit (111b) outputs, in a third period in which the decision processor (130b; 130f) determines that the composite sensor (1b) is in the impact applied state, an average of the first angular velocity signal (ωx) over a sixth period as the first angular velocity average signal (ω0x). The sixth period is longer than the fifth period. The second angular velocity averaging unit (112b) outputs, in the fourth period, an average of the second angular velocity signal (ωy) over a seventh period as the second angular velocity average signal (ω0y). The second angular velocity averaging unit (112b) outputs, in the third period, an average of the second angular velocity signal (ωy) over an eighth period as the second angular velocity average signal (ω0y). The eighth period is longer than the seventh period. The third angular velocity averaging unit (113b) outputs, in the fourth period, an average of the third angular velocity signal (ωz) over a ninth period as the third angular velocity average signal (ω0z). The third angular velocity averaging unit (113b) outputs, in the third period, an average of the third angular velocity signal (ωz) over a tenth period as the third angular velocity average signal (ω0z). The tenth period is longer than the ninth period.

The composite sensor (1b) according to the eighth aspect makes, in the third period in which impact is applied to the composite sensor (1b), periods for calculating the first to third angular velocity average signals (ω0x, ω0y, ω0z) longer than periods for calculating the first to third angular velocity average signals (ω0x, ω0y, ω0z) within the fourth period. This enables averaging the noise caused by the impact to the first to third angular velocity signals (ωx, ωy, ωz) and thereby reducing the effect of the noise.

In a composite sensor (1b) according to a ninth aspect, which may be implemented in conjunction with the eighth aspect, the first angular velocity averaging unit (111b) includes a first averaging circuit (121), a second averaging circuit (122), and a first selector (127). The first averaging circuit (121) calculates an average of the first angular velocity signal (ωx) over the fifth period. The second averaging circuit (122) calculates an average of the first angular velocity signal (ωx) over the sixth period. The second angular velocity averaging unit (112b) includes a third averaging circuit (123), a fourth averaging circuit (124), and a second selector (128). The third averaging circuit (123) calculates an average of the second angular velocity signal (ωy) over the seventh period. The fourth averaging circuit (124) calculates an average of the second angular velocity signal (ωy) over the eighth period. The third angular velocity averaging unit (113b) includes a fifth averaging circuit (125), a sixth averaging circuit (126), and a third selector (129). The fifth averaging circuit (125) calculates an average of the third angular velocity signal (ωz) over the ninth period. The sixth averaging circuit (126) calculates an average of the third angular velocity signal (ωz) over the tenth period. The first selector (127) selects, in the fourth period, the first averaging circuit (121) as a circuit that outputs the first angular velocity average signal (ω0x). The first selector (127) selects, in the third period, the second averaging circuit (122) as a circuit that outputs the first angular velocity average signal (ω0x). The second selector (128) selects, in the fourth period, the third averaging circuit (123) as a circuit that outputs the second angular velocity average signal (ω0y). The second selector (128) selects, in the third period, the fourth averaging circuit (124) as a circuit that outputs the second angular velocity average signal (ω0y). The third selector (129) selects, in the fourth period, the fifth averaging circuit (125) as a circuit that outputs the third angular velocity average signal (ω0z). The third selector (129) selects, in the third period, the sixth averaging circuit (126) as a circuit that outputs the third angular velocity average signal (ω0z).

The composite sensor (1b) according to the ninth aspect calculates, no matter whether the composite sensor (1b) is in the impact applied state or not, both the first to third angular velocity average signals (ω0x, ω0y, ω0z) for a situation where the composite sensor (1b) is in the impact applied state, and the first to third angular velocity average signals (ω0x, ω0y, ω0z) for a situation where the composite sensor (1b) is not in the impact applied state. This enables, when impact is applied to the composite sensor (1b), quickly using the first to third angular velocity average signals (ω0x, ω0y, ω0z) for the situation where the composite sensor (1b) is in the impact applied state.

In a composite sensor (1b) according to a tenth aspect, which may be implemented in conjunction with the eighth or ninth aspect, the decision processor (130b; 130f) includes an impact determiner (136; 136f) that determines whether the composite sensor (1b) is in the impact applied state. The impact determiner (136; 136f) determines, before beginning of the third period, that the composite sensor (1b) is in the impact applied state when at least one of: a condition that a value of the first angular velocity signal (ωx) be equal to or greater than a first angular velocity threshold value; a condition that a value of the second angular velocity signal (ωy) be equal to or greater than a second angular velocity threshold value; a condition that a value of the third angular velocity signal (ωz) be equal to or greater than a third angular velocity threshold value; a condition that a variation per unit time of the first acceleration signal (Ax) be equal to or greater than a first acceleration variation threshold value; a condition that a variation per unit time of the second acceleration signal (Ay) be equal to or greater than a second acceleration variation threshold value; or a condition that a variation per unit time of the third acceleration signal (Az) be equal to or greater than a third acceleration variation threshold value is satisfied.

The composite sensor (1b) according to the tenth aspect may highly accurately determine, based on respective time variations of the first to third acceleration signals (Ax, Ay, Az) and the first to third angular velocity signals (ωx, ωy, ωz), whether impact has been applied to the composite sensor (1b).

In a composite sensor (1b) according to an eleventh aspect, which may be implemented in conjunction with the tenth aspect, the impact determiner (136) determines that the composite sensor (1b) is not in the impact applied state when finding, after having once determined that the composite sensor (1b) is in the impact applied state, that a value of the first angular velocity signal (ox) remains equal to or less than a fourth angular velocity threshold value for a predetermined period, that a value of the second angular velocity signal (ωy) remains equal to or less than a fifth angular velocity threshold value for the predetermined period, and that a value of the third angular velocity signal (ωz) remains equal to or less than a sixth angular velocity threshold value for the predetermined period. Otherwise, the impact determiner (136) determines that the composite sensor (1b) remain in the impact applied state.

The composite sensor (1b) according to the eleventh aspect determines, when finding that the respective values of the first to third angular velocity signals (ωx, ωy, ωz) remain sufficiently small for the predetermined period, that the composite sensor (1b) is not in the impact applied state. This allows the processing in the impact applied state to be finished after the effect of the impact on the first to third angular velocity signals (ωx, ωy, ωz) has diminished sufficiently.

In a composite sensor (1b) according to a twelfth aspect, which may be implemented in conjunction with the tenth aspect, the impact determiner (136f) determines that the composite sensor (1b) is not in the impact applied state when finding, after having once determined that the composite sensor (1b) is in the impact applied state, that a time average (ω1x) of the first angular velocity signal (ωx) remains equal to or less than a fourth angular velocity threshold value for a predetermined period, that a time average (ω1y) of the second angular velocity signal (ωy) remains equal to or less than a fifth angular velocity threshold value for the predetermined period, and that a time average (ω1z) of the third angular velocity signal (ωz) remains equal to or less than a sixth angular velocity threshold value for the predetermined period. Otherwise, the impact determiner (136f) determines that the composite sensor (1b) remain in the impact applied state.

The composite sensor (1b) according to the twelfth aspect determines, when finding that the respective average values of the first to third angular velocity signals (ωx, ωy, ωz) remain sufficiently small for the predetermined period, that the composite sensor (1b) is not in the impact applied state. This allows the processing in the impact applied state to be finished after the effect of the impact on the first to third angular velocity signals (ωx, ωy, ωz) has diminished sufficiently.

In a composite sensor (1b) according to a thirteenth aspect, which may be implemented in conjunction with the tenth aspect, the impact determiner (136f) determines that the composite sensor (1b) is not in the impact applied state when finding, after having once determined that the composite sensor (1b) is in the impact applied state, a time average (ω1x) of the first angular velocity signal (ωx) equal to or less than a fourth angular velocity threshold value, a time average (ω1y) of the second angular velocity signal (ωy) equal to or less than a fifth angular velocity threshold value, and a time average (ω1z) of the third angular velocity signal (ωz) equal to or less than a sixth angular velocity threshold value. Otherwise, the impact determiner (136f) determines that the composite sensor (1b) remain in the impact applied state.

The composite sensor (1b) according to the thirteenth aspect determines, when finding that the respective average values of the first to third angular velocity signals (ωx, ωy, ωz) remain sufficiently small for the predetermined period, that the composite sensor (1b) is not in the impact applied state. This allows the processing in the impact applied state to be finished after the effect of the impact on the first to third angular velocity signals (ωx, ωy, ωz) has diminished sufficiently.

### REFERENCE SIGNS LIST

1, 1a, 1b, 1c, 1d, 1e Composite Sensor
11 Angular Velocity Detection Element (First Angular Velocity Detection Element)
12 Angular Velocity Detection Element (Second Angular Velocity Detection Element)
13 Angular Velocity Detection Element (Third Angular Velocity Detection Element)
21 Acceleration Detection Element (First Acceleration Detection Element)
22 Acceleration Detection Element (Second Acceleration Detection Element)
23 Acceleration Detection Element (Third Acceleration Detection Element)
100, 100a, 100b, 100c, 100d, 100e Control Circuit
111, 111b Angular Velocity Averaging Unit (First Angular Velocity Averaging Unit)
121 First Averaging Circuit
122 Second Averaging Circuit
127 First Selector
112, 112b Angular Velocity Averaging Unit (Second Angular Velocity Averaging Unit)
123 Third Averaging Circuit
124 Fourth Averaging Circuit
128 Second Selector
113, 113b Angular Velocity Averaging Unit (Third Angular Velocity Averaging Unit)
125 Fifth Averaging Circuit
126 Sixth Averaging Circuit
129 Third Selector
141, 141d, 141e Angular Velocity Offset Magnitude Calculator
142 Angular Velocity Corrector
130, 130a, 130b, 130f Decision Processor
131 Angular Velocity Variation Calculator
132 Acceleration Variation Calculator
133, 133a Applied State Determiner
134 Angular Velocity Average Value Calculator
135 Acceleration Average Value Calculator
136, 136f Impact Determiner
139 Linear Acceleration Calculator
151 Acceleration Averaging Unit (First Acceleration Averaging Unit)
152 Acceleration Averaging Unit (Second Acceleration Averaging Unit)
153 Acceleration Averaging Unit (Third Acceleration Averaging Unit)
161, 161c Acceleration Offset Magnitude Calculator
162 Acceleration Corrector
170 Signal Processor
180, 180c Acceleration Calculator
ωx x-Axis Angular Velocity Signal (First Angular Velocity Signal)
ωy y-Axis Angular Velocity Signal (Second Angular Velocity Signal)
ωz z-Axis Angular Velocity Signal (Third Angular Velocity Signal)
ω0x x-Axis Angular Velocity Average Signal (First Angular Velocity Average Signal)
ω0y y-Axis Angular Velocity Average Signal (Second Angular Velocity Average Signal)
ω0z z-Axis Angular Velocity Average Signal (Third Angular Velocity Average Signal)
ωcx x-Axis Angular Velocity Correction Signal (First Angular Velocity Correction Signal)
ωcy y-Axis Angular Velocity Correction Signal (Second Angular Velocity Correction Signal)
ωcz z-Axis Angular Velocity Correction Signal (Third Angular Velocity Correction Signal)
ωax x-Axis Corrected Angular Velocity Signal (First Corrected Angular Velocity Signal)
ωay y-Axis Corrected Angular Velocity Signal (Second Corrected Angular Velocity Signal)
ωaz z-Axis Corrected Angular Velocity Signal (Third Corrected Angular Velocity Signal)
ω1x x-Axis Angular Velocity Average Value (First Angular Velocity Average Value)
ω1y y-Axis Angular Velocity Average Value (Second Angular Velocity Average Value)
ω1z z-Axis Angular Velocity Average Value (Third Angular Velocity Average Value)
Ax x-Axis Acceleration Signal (First Acceleration Signal)
Ay y-Axis Acceleration Signal (Second Acceleration Signal)
Az z-Axis Acceleration Signal (Third Acceleration Signal)
A0x x-Axis Acceleration Average Signal (First Acceleration Average Signal)
A0y y-Axis Acceleration Average Signal (Second Acceleration Average Signal)
A0z z-Axis Acceleration Average Signal (Third Acceleration Average Signal)
Acx x-Axis Acceleration Correction Signal (First Acceleration Correction Signal)
Acy y-Axis Acceleration Correction Signal (Second Acceleration Correction Signal)
Acz z-Axis Acceleration Correction Signal (Third Acceleration Correction Signal)
Aax x-Axis Corrected Acceleration Signal (First Corrected Acceleration Signal)
Aay y-Axis Corrected Acceleration Signal (Second Corrected Acceleration Signal)
Aaz z-Axis Corrected Acceleration Signal (Third Corrected Acceleration Signal)
A1x x-Axis Acceleration Average Value (First Acceleration Average Value)
A1y y-Axis Acceleration Average Value (Second Acceleration Average Value)
A1z z-Axis Acceleration Average Value (Third Acceleration Average Value)
Q0 Quaternion Signal
G0 Gravitational Acceleration
G0x x-Axis Gravitational Acceleration Signal (First Gravitational Acceleration Signal)
G0y y-Axis Gravitational Acceleration Signal (Second Gravitational Acceleration Signal)
G0z z-Axis Gravitational Acceleration Signal (Third Gravitational Acceleration Signal)
L0 Linear Acceleration
L0x x-Axis Linear Acceleration Signal (First Linear Acceleration Signal)
L0y y-Axis Linear Acceleration Signal (Second Linear Acceleration Signal)
L0z z-Axis Linear Acceleration Signal (Third Linear Acceleration Signal)
L1x x-Axis Linear Acceleration Average Value (First Linear Acceleration Average Value)
L1y y-Axis Linear Acceleration Average Value (Second Linear Acceleration Average Value)
L1z z-Axis Linear Acceleration Average Value (Third Linear Acceleration Average Value)

1. A composite sensor comprising:
a first angular velocity detection element configured to detect angular velocity around a first detection axis to output a first angular velocity signal;
a second angular velocity detection element configured to detect angular velocity around a second detection axis to output a second angular velocity signal;
a third angular velocity detection element configured to detect angular velocity around a third detection axis to output a third angular velocity signal;
a first acceleration detection element configured to detect acceleration in a direction aligned with the first detection axis to output a first acceleration signal;
a second acceleration detection element configured to detect acceleration in a direction aligned with the second detection axis to output a second acceleration signal;
a third acceleration detection element configured to detect acceleration in a direction aligned with the third detection axis to output a third acceleration signal; and
a control circuit configured to process the first angular velocity signal, the second angular velocity signal, the third angular velocity signal, the first acceleration signal, the second acceleration signal, and the third acceleration signal,
the first detection axis, the second detection axis, and the third detection axis being perpendicular to each other,
the control circuit including:
a first acceleration averaging unit configured to calculate a time average of the first acceleration signal to generate a first acceleration average signal;
a second acceleration averaging unit configured to calculate a time average of the second acceleration signal to generate a second acceleration average signal;
a third acceleration averaging unit configured to calculate a time average of the third acceleration signal to generate a third acceleration average signal;
a decision processor configured to determine whether the composite sensor is in an applied state in which at least one of angular velocity or acceleration is applied to the composite sensor;
an acceleration offset magnitude calculator configured to calculate respective magnitudes of offset correction with respect to the first acceleration average signal, the second acceleration average signal, and the third acceleration average signal, to output a first acceleration correction signal, a second acceleration correction signal, and a third acceleration correction signal, respectively;
an acceleration corrector configured to apply the first acceleration correction signal to the first acceleration average signal to output a first corrected acceleration signal, apply the second acceleration correction signal to the second acceleration average signal to output a second corrected acceleration signal, and apply the third acceleration correction signal to the third acceleration average signal to output a third corrected acceleration signal;
a signal processor configured to output a quaternion signal based on angular velocity information, the first corrected acceleration signal, the second corrected acceleration signal, and the third corrected acceleration signal, the angular velocity information being based on the first angular velocity signal, the second angular velocity signal, and the third angular velocity signal; and
an acceleration calculator configured to calculate, based on the quaternion signal, at least one of gravitational acceleration or linear acceleration as acceleration information,
the acceleration offset magnitude calculator being configured to calculate, in accordance with the acceleration information in a second period in which the decision processor has determined that the composite sensor is not in the applied state, the first acceleration correction signal, the second acceleration correction signal, and the third acceleration correction signal for a first period in which the decision processor has determined that the composite sensor is in the applied state.

2. The composite sensor of claim 1, wherein
the acceleration information is the gravitational acceleration,
the acceleration calculator is configured to calculate, as the gravitational acceleration, a first gravitational acceleration signal as a component aligned with the first detection axis, a second gravitational acceleration signal as a component aligned with the second detection axis, and a third gravitational acceleration signal as a component aligned with the third detection axis, and
the acceleration offset magnitude calculator is configured to
calculate, based on a first linear acceleration signal, the first acceleration correction signal for the first period, the first linear acceleration signal representing a difference between the first acceleration average signal and the first gravitational acceleration signal for the second period;
calculate, based on a second linear acceleration signal, the second acceleration correction signal for the first period, the second linear acceleration signal representing a difference between the second acceleration average signal and the second gravitational acceleration signal for the second period; and
calculate, based on a third linear acceleration signal, the third acceleration correction signal for the first period, the third linear acceleration signal representing a difference between the third acceleration average signal and the third gravitational acceleration signal for the second period.

3. The composite sensor of claim 1, wherein
the acceleration information is the linear acceleration,
the acceleration calculator is configured to calculate, as the linear acceleration, a first linear acceleration signal as a component aligned with the first detection axis, a second linear acceleration signal as a component aligned with the second detection axis, and a third linear acceleration signal as a component aligned with the third detection axis, and
the acceleration offset magnitude calculator is configured to
calculate, based on the first linear acceleration signal for the second period, the first acceleration correction signal for the first period;
calculate, based on the second linear acceleration signal for the second period, the second acceleration correction signal for the first period; and
calculate, based on the third linear acceleration signal for the second period, the third acceleration correction signal for the first period.

4. The composite sensor of claim 1, wherein
the control circuit further includes:
a first angular velocity averaging unit configured to calculate a time average of the first angular velocity signal to generate a first angular velocity average signal;
a second angular velocity averaging unit configured to calculate a time average of the second angular velocity signal to generate a second angular velocity average signal;
a third angular velocity averaging unit configured to calculate a time average of the third angular velocity signal to generate a third angular velocity average signal;
an angular velocity offset magnitude calculator configured to calculate respective magnitudes of offset correction with respect to the first angular velocity average signal, the second angular velocity average signal, and the third angular velocity average signal to output a first angular velocity correction signal, a second angular velocity correction signal, and a third angular velocity correction signal, respectively, and
an angular velocity corrector configured to apply the first angular velocity correction signal to the first angular velocity average signal to output a first corrected angular velocity signal, apply the second angular velocity correction signal to the second angular velocity average signal to output a second corrected angular velocity signal, and apply the third angular velocity correction signal to the third angular velocity average signal to output a third corrected angular velocity signal,
the signal processor is configured to use, as the angular velocity information, the first corrected angular velocity signal, the second corrected angular velocity signal, and the third corrected angular velocity signal, and
the angular velocity offset magnitude calculator is configured to:
calculate, based on the first angular velocity signal for the second period, the first angular velocity correction signal for the first period;
calculate, based on the second angular velocity signal for the second period, the second angular velocity correction signal for the first period; and
calculate, based on the third angular velocity signal for the second period, the third angular velocity correction signal for the first period.

5. The composite sensor of claim 1, wherein
the decision processor includes:
an angular velocity variation calculator configured to calculate an angular velocity variation squared variance value representing a variance of respective time variations of the first angular velocity signal, the second angular velocity signal, and the third angular velocity signal;
an acceleration variation calculator configured to calculate an acceleration variation squared variance value representing a variance of respective time variations of the first acceleration signal, the second acceleration signal, and the third acceleration signal; and
an applied state determiner configured to determine, based on the angular velocity variation squared variance value and the acceleration variation squared variance value, whether the composite sensor is in the applied state,
the applied state determiner is configured to determine that the composite sensor is not in the applied state when finding the angular velocity variation squared variance value equal to or less than an angular velocity variance threshold value and finding the acceleration variation squared variance value equal to or less than an acceleration variance threshold value and otherwise determine that the composite sensor is in the applied state.

6. The composite sensor of claim 2, wherein
the decision processor includes:
an angular velocity average value calculator configured to calculate a first angular velocity average value, a second angular velocity average value, and a third angular velocity average value as respective time averages of the first angular velocity signal, the second angular velocity signal, and the third angular velocity signal;
an acceleration average value calculator configured to calculate a first acceleration average value, a second acceleration average value, and a third acceleration average value as respective time averages of the first acceleration signal, the second acceleration signal, and the third acceleration signal;
a linear acceleration calculator configured to calculate a first linear acceleration average value, a second linear acceleration average value, and a third linear acceleration average value based on the gravitational acceleration, the first acceleration average value, the second acceleration average value, and the third acceleration average value; and
an applied state determiner configured to determine, based on the first angular velocity average value, the second angular velocity average value, the third angular velocity average value, the first linear acceleration average value, the second linear acceleration average value, and the third linear acceleration average value, whether the composite sensor is in the applied state,
the linear acceleration calculator is configured to:
calculate a difference between the first acceleration average value and the first gravitational acceleration signal as the first linear acceleration average value;
calculate a difference between the second acceleration average value and the second gravitational acceleration signal as the second linear acceleration average value; and
calculate a difference between the third acceleration average value and the third gravitational acceleration signal as the third linear acceleration average value, and
the applied state determiner is configured to determine that the composite sensor is not in the applied state when finding:
the first angular velocity average value equal to or less than a first threshold value,
the second angular velocity average value equal to or less than a second threshold value,
the third angular velocity average value equal to or less than a third threshold value,
the first linear acceleration average value equal to or less than a fourth threshold value,
the second linear acceleration average value equal to or less than a fifth threshold value, and
the third linear acceleration average value equal to or less than a sixth threshold value, and
otherwise determine that the composite sensor is in the applied state.

7. The composite sensor of claim 2, wherein
the decision processor includes:
an angular velocity variation calculator configured to calculate an angular velocity variation squared variance value representing a variance of respective time variations of the first angular velocity signal, the second angular velocity signal, and the third angular velocity signal;
an acceleration variation calculator configured to calculate an acceleration variation squared variance value representing a variance of respective time variations of the first acceleration signal, the second acceleration signal, and the third acceleration signal;
an angular velocity average value calculator configured to calculate a first angular velocity average value, a second angular velocity average value, and a third angular velocity average value as respective time averages of the first angular velocity signal, the second angular velocity signal, and the third angular velocity signal;
an acceleration average value calculator configured to calculate a first acceleration average value, a second acceleration average value, and a third acceleration average value as respective time averages of the first acceleration signal, the second acceleration signal, and the third acceleration signal;
a linear acceleration calculator configured to calculate a first linear acceleration average value, a second linear acceleration average value, and a third linear acceleration average value based on the gravitational acceleration, the first acceleration average value, the second acceleration average value, and the third acceleration average value; and
an applied state determiner configured to determine whether the composite sensor is in the applied state,
the linear acceleration calculator is configured to:
calculate a difference between the first acceleration average value and the first gravitational acceleration signal as the first linear acceleration average value;
calculate a difference between the second acceleration average value and the second gravitational acceleration signal as the second linear acceleration average value; and
calculate a difference between the third acceleration average value and the third gravitational acceleration signal as the third linear acceleration average value, and the applied state determiner is configured to determine that the composite sensor is not in the applied state when finding:
the angular velocity variation squared variance value equal to or less than an angular velocity variance threshold value;
the acceleration variation squared variance value equal to or less than an acceleration variance threshold value;
the first angular velocity average value equal to or less than a first threshold value,
the second angular velocity average value equal to or less than a second threshold value,
the third angular velocity average value equal to or less than a third threshold value,
the first linear acceleration average value equal to or less than a fourth threshold value,
the second linear acceleration average value equal to or less than a fifth threshold value, and
the third linear acceleration average value equal to or less than a sixth threshold value, and
otherwise determine that the composite sensor is in the applied state.

8. The composite sensor of claim 4, wherein
the decision processor is configured to further determine whether the composite sensor is in an impact applied state where impact is applied to the composite sensor,
the first angular velocity averaging unit is configured to:
output, in a fourth period in which the decision processor determines that the composite sensor is not in the impact applied state, an average of the first angular velocity signal over a fifth period as the first angular velocity average signal; and
output, in a third period in which the decision processor determines that the composite sensor is in the impact applied state, an average of the first angular velocity signal over a sixth period as the first angular velocity average signal, the sixth period being longer than the fifth period,
the second angular velocity averaging unit is configured to:
output, in the fourth period, an average of the second angular velocity signal over a seventh period as the second angular velocity average signal; and
output, in the third period, an average of the second angular velocity signal over an eighth period as the second angular velocity average signal, the eighth period being longer than the seventh period, and
the third angular velocity averaging unit is configured to:
output, in the fourth period, an average of the third angular velocity signal over a ninth period as the third angular velocity average signal; and
output, in the third period, an average of the third angular velocity signal over a tenth period as the third angular velocity average signal, the tenth period being longer than the ninth period.

9. The composite sensor of claim 8, wherein
the first angular velocity averaging unit includes:
a first averaging circuit configured to calculate an average of the first angular velocity signal over the fifth period;
a second averaging circuit configured to calculate an average of the first angular velocity signal over the sixth period; and
a first selector,
the second angular velocity averaging unit includes:
a third averaging circuit configured to calculate an average of the second angular velocity signal over the seventh period;
a fourth averaging circuit configured to calculate an average of the second angular velocity signal over the eighth period; and
a second selector,
the third angular velocity averaging unit includes:
a fifth averaging circuit configured to calculate an average of the third angular velocity signal over the ninth period;
a sixth averaging circuit configured to calculate an average of the third angular velocity signal over the tenth period; and
a third selector,
the first selector is configured to:
select, in the fourth period, the first averaging circuit as a circuit that outputs the first angular velocity average signal; and
select, in the third period, the second averaging circuit as a circuit that outputs the first angular velocity average signal,
the second selector is configured to:
select, in the fourth period, the third averaging circuit as a circuit that outputs the second angular velocity average signal; and
select, in the third period, the fourth averaging circuit as a circuit that outputs the second angular velocity average signal, and
the third selector is configured to:
select, in the fourth period, the fifth averaging circuit as a circuit that outputs the third angular velocity average signal; and
select, in the third period, the sixth averaging circuit as a circuit that outputs the third angular velocity average signal.

10. The composite sensor of claim 8, wherein
the decision processor includes an impact determiner configured to determine whether the composite sensor is in the impact applied state, and
the impact determiner is configured to, before beginning of the third period, determine that the composite sensor is in the impact applied state when at least one of:
a condition that a value of the first angular velocity signal be equal to or greater than a first angular velocity threshold value;
a condition that a value of the second angular velocity signal be equal to or greater than a second angular velocity threshold value;
a condition that a value of the third angular velocity signal be equal to or greater than a third angular velocity threshold value;
a condition that a variation per unit time of the first acceleration signal be equal to or greater than a first acceleration variation threshold value;
a condition that a variation per unit time of the second acceleration signal be equal to or greater than a second acceleration variation threshold value; or
a condition that a variation per unit time of the third acceleration signal be equal to or greater than a third acceleration variation threshold value is satisfied.

11. The composite sensor of claim 10, wherein
the impact determiner is configured to determine that the composite sensor is not in the impact applied state when finding, after having once determined that the composite sensor is in the impact applied state,
that a value of the first angular velocity signal remains equal to or less than a fourth angular velocity threshold value for a predetermined period,
that a value of the second angular velocity signal remains equal to or less than a fifth angular velocity threshold value for the predetermined period, and
that a value of the third angular velocity signal remains equal to or less than a sixth angular velocity threshold value for the predetermined period, and
otherwise determine that the composite sensor remain in the impact applied state.

12. The composite sensor of claim 10, wherein
the impact determiner is configured to determine that the composite sensor is not in the impact applied state when finding, after having once determined that the composite sensor is in the impact applied state,
that a time average of the first angular velocity signal remains equal to or less than a fourth angular velocity threshold value for a predetermined period,
that a time average of the second angular velocity signal remains equal to or less than a fifth angular velocity threshold value for the predetermined period, and
that a time average of the third angular velocity signal remains equal to or less than a sixth angular velocity threshold value for the predetermined period, and
otherwise determine that the composite sensor remain in the impact applied state.

13. The composite sensor of claim 10, wherein
the impact determiner is configured to determine that the composite sensor is not in the impact applied state when finding, after having once determined that the composite sensor is in the impact applied state,
a time average of the first angular velocity signal equal to or less than a fourth angular velocity threshold value,
a time average of the second angular velocity signal equal to or less than a fifth angular velocity threshold value, and
a time average of the third angular velocity signal equal to or less than a sixth angular velocity threshold value, and
otherwise determine that the composite sensor remain in the impact applied state.
